(19) United States
(12) Patent Application Publication
(10) Pub. No.: US 2026/0081651 A1
(43) Pub. Date: Mar. 19, 2026

(54) TWO-STAGE TIME-DOMAIN UPLINK PRECODER INDICATION

(71) Applicant: QUALCOMM Incorporated, San Diego, CA (US)

(72) Inventors: In-Soo KIM, San Diego, CA (US); Yu ZHANG, San Diego, CA (US); Yisheng XUE, San Diego, CA (US); Jing SUN, San Diego, CA (US); Hyojin LEE, San Diego, CA (US); Jing JIANG, San Diego, CA (US)

(21) Appl. No.: 18/889,932

(22) Filed: Sep. 19, 2024

(51) Int. Cl. H04B 7/0456; H04W 72/1268

(52) U.S. Cl. CPC H04B 7/0478; H04W 72/1268

(57) ABSTRACT

Methods, systems, and devices for wireless communications are described. A user equipment (UE) may perform uplink codebook-based precoding in which a network entity may transmit downlink control information (DCI) to the UE to indicate an uplink precoder for the UE to use for a subsequent uplink transmission. A network entity may indicate in an uplink grant less than all of the time domain (TD) precoder coefficients of a TD precoder, and the network entity may indicate the indices of the TD precoder that correspond to the included TD precoder coefficients. The indicated TD precoder coefficients may correspond to the strongest (e.g., the highest value) TD precoder coefficients. When the UE transforms the TD uplink precoder to a frequency domain (FD) precoder using the indicated TD precoder coefficients, the resulting FD precoder may be approximate to the FD precoder that would be generated using all of the TD precoder coefficients.

### FIELD OF TECHNOLOGY

The following relates to wireless communications, including two-stage time-domain uplink precoder indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, an indication of a subset of time domain (TD) precoder indices of a set of multiple TD precoder indices associated with a communication channel between the UE and the network entity, where a quantity of the set of multiple TD precoder indices is equal to a quantity of physical resource block groups (PRGs) of the communication channel, receiving, from the network entity, an uplink grant that schedules an uplink shared channel communication, where the uplink grant indicates a respective TD precoder coefficient for each of the subset of TD precoder indices, generating a frequency domain (FD) precoder for the uplink shared channel communication based on each respective TD precoder coefficient, and transmitting, to the network entity, the uplink shared channel communication precoded in accordance with the FD precoder.

A UE for wireless communications is described. The UE may include one or more memories storing processor executable code, and one or more processors coupled with the one or more memories. The one or more processors may individually or collectively be operable to execute the code to cause the UE to receive, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel, receive, from the network entity, an uplink grant that schedules an uplink shared channel communication, where the uplink grant indicates a respective TD precoder coefficient for each of the subset of TD precoder indices, generate an FD precoder for the uplink shared channel communication based on each respective TD precoder coefficient, and transmit, to the network entity, the uplink shared channel communication precoded in accordance with the FD precoder.

Another UE for wireless communications is described. The UE may include means for receiving, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel, means for receiving, from the network entity, an uplink grant that schedules an uplink shared channel communication, where the uplink grant indicates a respective TD precoder coefficient for each of the subset of TD precoder indices, means for generating an FD precoder for the uplink shared channel communication based on each respective TD precoder coefficient, and means for transmitting, to the network entity, the uplink shared channel communication precoded in accordance with the FD precoder.

A non-transitory computer-readable medium storing code for wireless communications is described. The code may include instructions executable by one or more processors to receive, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel, receive, from the network entity, an uplink grant that schedules an uplink shared channel communication, where the uplink grant indicates a respective TD precoder coefficient for each of the subset of TD precoder indices, generate an FD precoder for the uplink shared channel communication based on each respective TD precoder coefficient, and transmit, to the network entity, the uplink shared channel communication precoded in accordance with the FD precoder.

In some examples of the method, UEs, and non-transitory computer-readable medium described herein, generating the FD precoder may include operations, features, means, or instructions for generating a TD precoder based on each respective TD precoder coefficient and based on a zero-value for a remainder of the set of multiple TD precoder indices that may be not included in the subset of TD precoder indices and applying a fast Fourier transform to the TD precoder to generate the FD precoder.

In some examples of the method, UEs, and non-transitory computer-readable medium described herein, the indication of the subset of TD precoder indices may be received via the uplink grant.

In some examples of the method, UEs, and non-transitory computer-readable medium described herein, the indication of the subset of TD precoder indices may be received via a first control message and the uplink grant may be received via a second control message.

Some examples of the method, UEs, and non-transitory computer-readable medium described herein may further include operations, features, means, or instructions for receiving, from the network entity, a second uplink grant via a third control message that schedules a second uplink shared channel communication, where the second uplink grant indicates a second respective TD precoder coefficient for each of the subset of TD precoder indices, generating a second FD precoder for the second uplink shared channel communication based on each second respective TD precoder coefficient, and transmitting, to the network entity, the second uplink shared channel communication precoded in accordance with the second FD precoder.

Some examples of the method, UEs, and non-transitory computer-readable medium described herein may further include operations, features, means, or instructions for generating the second FD precoder may be based on the subset of TD precoder indices indicated in the third control message matching the subset of TD precoder indices in the first control message.

Some examples of the method, UEs, and non-transitory computer-readable medium described herein may further include operations, features, means, or instructions for receiving, via the first control message, information that indicates a quantity of resource blocks (RBs) associated with the set of multiple TD precoder indices and a quantity of resource blocks per PRG.

Some examples of the method, UEs, and non-transitory computer-readable medium described herein may further include operations, features, means, or instructions for receiving, from the network entity and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices, generating a second FD precoder for the second uplink shared channel communication based on only one second respective TD precoder coefficient based on an absence of reception of a fourth control message that indicates the second subset of TD precoder indices of the set of multiple TD precoder indices, and transmitting, to the network entity, the second uplink shared channel communication precoded in accordance with the second FD precoder.

Some examples of the method, UEs, and non-transitory computer-readable medium described herein may further include operations, features, means, or instructions for receiving, from the network entity and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices and refraining from transmitting the second uplink shared channel communication based on an absence of reception of a fourth control message that indicates the second subset of TD precoder indices of the set of multiple TD precoder indices.

Some examples of the method, UEs, and non-transitory computer-readable medium described herein may further include operations, features, means, or instructions for receiving, from the network entity and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices and transmitting, to the network entity, the second uplink shared channel communication precoded in accordance with a default FD precoder based on an absence of reception of a fourth control message that indicates the second subset of TD precoder indices of the set of multiple TD precoder indices.

Some examples of the method, UEs, and non-transitory computer-readable medium described herein may further include operations, features, means, or instructions for receiving, from the network entity, a third control message that indicates a quantity of TD precoder indices in the TD precoder indices, where the third control message further indicates a quantity of bits to use for indication of each respective TD precoder coefficient, where reception of the first control message and the second control message may be based on reception of the third control message.

In some examples of the method, UEs, and non-transitory computer-readable medium described herein, the uplink grant indicates the respective TD precoder coefficient for each of the subset of TD precoder indices via indication of a respective quantized phase and amplitude for each of the subset of TD precoder indices.

In some examples of the method, UEs, and non-transitory computer-readable medium described herein, the uplink grant indicates the respective TD precoder coefficient for each of the subset of TD precoder indices via indication of a respective codeword from a codebook for each of the subset of TD precoder indices.

Some examples of the method, UEs, and non-transitory computer-readable medium described herein may further include operations, features, means, or instructions for transmitting a set of multiple sounding reference signals via the communication channel, where reception of the indication of the subset of TD precoder indices may be based on transmission of the set of multiple sounding reference signals.

A method for wireless communications by a network entity is described. The method may include transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel, transmitting, to the UE, an uplink grant that schedules an uplink shared channel communication, where the uplink grant indicates a respective TD precoder coefficient for each of the subset of TD precoder indices, and receiving, from the UE, the uplink shared channel communication precoded in accordance with an FD precoder based on each respective TD precoder coefficient.

A network entity for wireless communications is described. The network entity may include one or more memories storing processor executable code, and one or more processors coupled with the one or more memories. The one or more processors may individually or collectively be operable to execute the code to cause the network entity to transmit, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel, transmit, to the UE, an uplink grant that schedules an uplink shared channel communication, where the uplink grant indicates a respective TD precoder coefficient for each of the subset of TD precoder indices, and receive, from the UE, the uplink shared channel communication precoded in accordance with an FD precoder based on each respective TD precoder coefficient.

Another network entity for wireless communications is described. The network entity may include means for transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel, means for transmitting, to the UE, an uplink grant that schedules an uplink shared channel communication, where the uplink grant indicates a respective TD precoder coefficient for each of the subset of TD precoder indices, and means for receiving, from the UE, the uplink shared channel communication precoded in accordance with an FD precoder based on each respective TD precoder coefficient.

A non-transitory computer-readable medium storing code for wireless communications is described. The code may include instructions executable by one or more processors to transmit, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel, transmit, to the UE, an uplink grant that schedules an uplink shared channel communication, where the uplink grant indicates a respective TD precoder coefficient for each of the subset of TD precoder indices, and receive, from the UE, the uplink shared channel communication precoded in accordance with an FD precoder based on each respective TD precoder coefficient.

Some examples of the method, network entities, and non-transitory computer-readable medium described herein may further include operations, features, means, or instructions for receiving, from the UE, a set of multiple sounding reference signals via the communication channel, generating the FD precoder based on the set of multiple sounding reference signals, generating a TD precoder based on the FD precoder, the TD precoder including a respective TD precoder coefficient for each of the set of multiple TD precoder indices, and selecting the subset of TD precoder indices from the set of multiple TD precoder indices based on the respective TD precoder coefficient for the subset of TD precoder indices satisfying a threshold.

In some examples of the method, network entities, and non-transitory computer-readable medium described herein, generating the TD precoder may include operations, features, means, or instructions for applying an inverse fast Fourier transform to the FD precoder to generate the TD precoder.

In some examples of the method, network entities, and non-transitory computer-readable medium described herein, the indication of the subset of TD precoder indices may be transmitted via the uplink grant.

In some examples of the method, network entities, and non-transitory computer-readable medium described herein, the indication of the subset of TD precoder indices may be received via a first control message and the uplink grant may be received via a second control message.

Some examples of the method, network entities, and non-transitory computer-readable medium described herein may further include operations, features, means, or instructions for transmitting, to the UE, a second uplink grant via a third control message that schedules a second uplink shared channel communication, where the second uplink grant indicates a second respective TD precoder coefficient for each of the subset of TD precoder indices and receiving, from the UE, the second uplink shared channel communication in accordance with a second FD precoder based on each second respective TD precoder coefficient.

Some examples of the method, network entities, and non-transitory computer-readable medium described herein may further include operations, features, means, or instructions for receiving the second uplink shared channel communication in accordance with the second FD precoder may be based on the subset of TD precoder indices indicated in the third control message matching the subset of TD precoder indices in the first control message.

Some examples of the method, network entities, and non-transitory computer-readable medium described herein may further include operations, features, means, or instructions for transmitting, via the first control message, information that indicates a quantity of RBs associated with the set of multiple TD precoder indices and a quantity of RBs per PRG.

Some examples of the method, network entities, and non-transitory computer-readable medium described herein may further include operations, features, means, or instructions for transmitting, to the UE and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices and receiving, from the UE, the second uplink shared channel communication in accordance with a second FD precoder based on only one second respective TD precoder coefficient based on an absence of transmission of a fourth control message that indicates the second subset of TD precoder indices of the set of multiple TD precoder indices.

Some examples of the method, network entities, and non-transitory computer-readable medium described herein may further include operations, features, means, or instructions for transmitting, to the UE and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices and receiving, from the UE, the second uplink shared channel communication in accordance with a default FD precoder based on an absence of transmission of a fourth control message that indicates the second subset of TD precoder indices of the set of multiple TD precoder indices.

Some examples of the method, network entities, and non-transitory computer-readable medium described herein may further include operations, features, means, or instructions for transmitting, to the UE, a third control message that indicates a quantity of TD precoder indices in the TD precoder indices, where the third control message further indicates a quantity of bits to use for indication of each respective TD precoder coefficient.

In some examples of the method, network entities, and non-transitory computer-readable medium described herein, the uplink grant indicates the respective TD precoder coefficient for each of the subset of TD precoder indices via indication of a respective quantized phase and amplitude for each of the subset of TD precoder indices.

In some examples of the method, network entities, and non-transitory computer-readable medium described herein, the uplink grant indicates the respective TD precoder coefficient for each of the subset of TD precoder indices via indication of a respective codeword from a codebook for each of the subset of TD precoder indices.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports two-stage time-domain uplink precoder indication in accordance with one or more aspects of the present disclosure.

FIG. 2 shows an example of a wireless communications system that supports two-stage time-domain uplink precoder indication in accordance with one or more aspects of the present disclosure.

FIG. 3 shows an example of a process flow that supports two-stage time-domain uplink precoder indication in accordance with one or more aspects of the present disclosure.

FIG. 4 shows an example of a precoder flow diagram that supports two-stage time-domain uplink precoder indication in accordance with one or more aspects of the present disclosure.

FIG. 5 shows an example of a process flow that supports two-stage time-domain uplink precoder indication in accordance with one or more aspects of the present disclosure.

FIG. 6 shows an example of a resource and precoder diagram that supports two-stage time-domain uplink precoder indication in accordance with one or more aspects of the present disclosure.

FIG. 7 shows an example of a process flow that supports two-stage time-domain uplink precoder indication in accordance with one or more aspects of the present disclosure.

FIGS. 8 and 9 show block diagrams of devices that support two-stage time-domain uplink precoder indication in accordance with one or more aspects of the present disclosure.

FIG. 10 shows a block diagram of a communications manager that supports two-stage time-domain uplink precoder indication in accordance with one or more aspects of the present disclosure.

FIG. 11 shows a diagram of a system including a device that supports two-stage time-domain uplink precoder indication in accordance with one or more aspects of the present disclosure.

FIGS. 12 and 13 show block diagrams of devices that support two-stage time-domain uplink precoder indication in accordance with one or more aspects of the present disclosure.

FIG. 14 shows a block diagram of a communications manager that supports two-stage time-domain uplink precoder indication in accordance with one or more aspects of the present disclosure.

FIG. 15 shows a diagram of a system including a device that supports two-stage time-domain uplink precoder indication in accordance with one or more aspects of the present disclosure.

FIGS. 16 and 17 show flowcharts illustrating methods that support two-stage time-domain uplink precoder indication in accordance with one or more aspects of the present disclosure.

### DETAILED DESCRIPTION

In some communications systems, a user equipment (UE) may perform uplink codebook-based precoding in which a network entity may transmit downlink control information (DCI) to the UE to indicate an uplink precoder for the UE to use for a subsequent uplink transmission. For example, a value in a transmitting precoding matrix indicator (TPMI) field in the DCI may indicate a precoding matrix from a set of precoding matrices in a codebook. As the quantity of UE antennas increases, the size of the codebook may increase, and more bits may be demanded in the TPMI field to point to a precoding matrix. Additionally, in multi-user (MU) multiple input multiple output (MU-MIMO), the network may jointly design precoders across UEs that transmit uplink transmissions simultaneously. In MU-MIMO, precoding gain may be achieved by subband precoding (e.g., per physical resource block group (PRG)) as compared to wideband precoding where the TPMI is indicated across the entire wideband (e.g., across the uplink channel that includes multiple PRGs). TPMI indication in DCI may be supported per wideband, but may not be supported on a per subband basis. Additionally, indicating a separate TPMI for each PRG (e.g., indication of TPMI on a per subband basis) in DCI may involve significant signaling overhead.

Aspects of this disclosure relate to indication of a single uplink time domain (TD) precoder across multiple PRGs to reduce the signaling overhead, where the TD uplink precoder is generated using subband precoding. To reduce signaling overhead, the network may indicate in an uplink grant (e.g., the DCI that schedules an uplink shared channel communication) less than all of the TD precoder coefficients of the TD uplink precoder, and the network may indicate the indices (e.g., taps) of the TD uplink precoder that correspond to the included TD uplink precoder coefficients. The indicated TD uplink precoder coefficients may correspond to the strongest (e.g., the highest value) TD uplink precoder coefficients. Accordingly, when the UE transforms the TD uplink precoder to a frequency domain (FD) uplink precoder using the indicated TD uplink precoder coefficients (e.g., via application of a Fast Fourier Transform (FFT) to the indicated TD uplink precoder coefficients), the resulting FD uplink precoder may be approximate to the FD uplink precoder that would be generated using all of the TD uplink precoder coefficients (e.g., and not just the subset of the TD uplink precoder coefficients). The strongest TD uplink precoder indices may change infrequently, and accordingly in some examples the network may perform a two-stage uplink precoder indication. For example, the network may indicate the TD uplink precoder indices in a first control message (e.g., a medium access control (MAC) control element (MAC-CE)), and the network may subsequently indicate the TD uplink precoder coefficients that correspond to the indicated TD uplink precoder indices in the uplink grant (e.g., the DCI) for a particular uplink transmission. In some examples, the network may transmit multiple uplink grants scheduling multiple respective uplink transmissions after indicating the TD uplink precoder indices.

Aspects of the disclosure are initially described in the context of wireless communications systems. Aspects of the disclosure are further illustrated by and described with reference to process flows, precoder flow diagrams, resource and precoder diagrams, apparatus diagrams, system diagrams, and flowcharts that relate to two-stage time-domain uplink precoder indication.

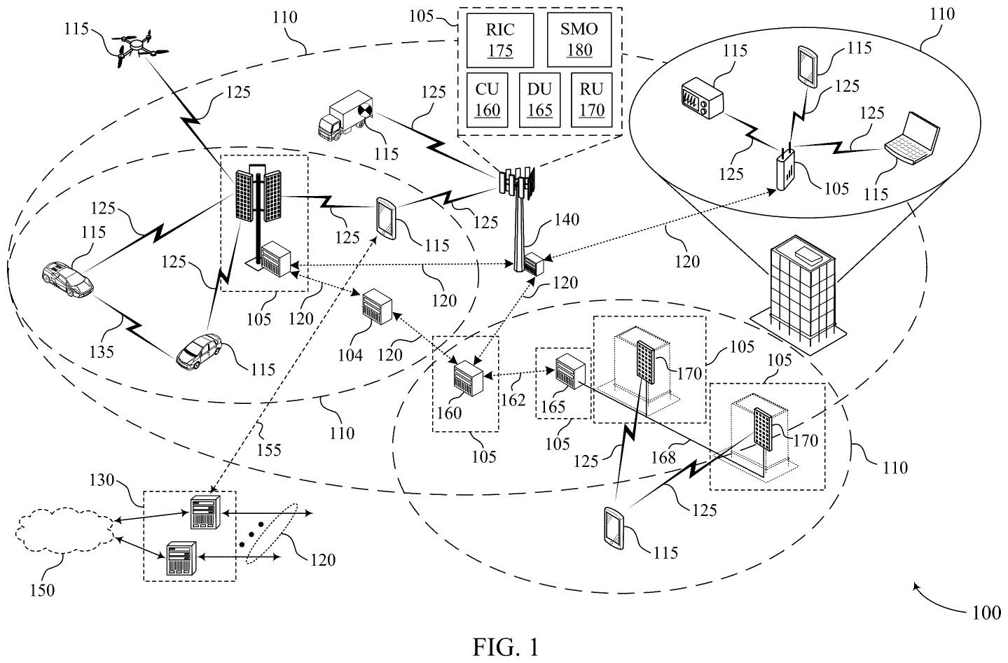

FIG. 1 shows an example of a wireless communications system 100 that supports two-stage time-domain uplink precoder indication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support two-stage time-domain uplink precoder indication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the TD) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the TD) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples. A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may perform uplink codebook-based precoding in which a network entity 105 may transmit DCI to the UE 115 to indicate an uplink precoder for the UE 115 to use for a subsequent uplink transmission (e.g., for a physical uplink shared channel (PUSCH) transmission).

In MU-MIMO, the network entity 105 may jointly design precoders across UEs 115 that transmit uplink transmissions simultaneously. The network entity 105 accordingly may receive the uplink transmissions from the multiple UEs 115 simultaneously (or within a small arrival window). In some examples, in MU-MIMO precoding, a constant-modulus precoder (e.g., an NR PUSCH codebook (CB)) may be used. In some examples, a more granular CB may be used for uplink MU-MIMO without a constant-modulus constraint to achieve higher gain as compared to open-loop precoding. In MU-MIMO precoding gain may be achieved by subband precoding (e.g., per PRG) as compared to wideband precoding where the TPMI is indicated across the entire wideband (e.g., across the uplink channel). Experimentally, subband precoding has been shown to achieve higher uplink MU-MIMO precoding gain than using a more granular CB without a constant-modulus constraint. For example, performance degradation due to constraints on the NR PUSCH CB (e.g., constant-modulus constraints, finite quantities of codewords) may be negligible, and accordingly increasing the granularity of the NR PUSCH codebook may have limited impact on uplink MU-MIMO precoding gain.

For example, in an experiment with parameters as shown in Table 1, five precoding schemes and precoder designs were tested as shown in Table 2.

TABLE 1

| Parameters | Values | |
|---|---|---|
| Carrier frequency | 2 | GHz |
| Bandwidth | 20 MHz (52 RB) | |
| Subcarrier spacing | 30 | kHz |

| | |
|---|---|
| gNB antenna | 2 H × 1 V × 2 P (4 ports) |
| UE antenna | 1 H × 1 V × 2 P (2 ports) |
| Quantity of layers per UE | 1 |
| Quantity of UEs | 4 |
| Channel model | TDLA_100ns_11Hz_XPol_lowAntCorr |
| PRG | {4 RB, WB (52 RB)} |
| Receive Algorithm | MMSE-IRC |
| Channel estimation | Ideal/Perfect |

TABLE 2

| Precoding | Precoder | Precoder | Precoder | |
|---|---|---|---|---|
| Scheme | Design | Constraint | Granularity | Notes |
| NR Baseline 1 | Joint MU- | NR PUSCH | WB | — |
| | MIMO | CB | | |
| NR Baseline 2 | SU- | NR PUSCH | WB | MU-Ignorant |
| | MIMO | CB | | spatial division |
| | | | | multiple access |
| | | | | (SDMA) |
| NR | Joint MU- | — | Subband | Subband + |
| Enhancement 1 | MIMO | | | Finer CB |
| NR | Joint MU- | NR PUSCH | Subband | Subband |
| Enhancement 2 | MIMO | CB | | |
| NR | Joint MU- | — | WB | Finer CB |
| Enhancement 3 | MIMO | | | |

NR enhancement 1 and NR enhancement 2 in Table 2 achieved the same 100 MbpS as NR Baseline 1, NR Baseline 2, and NR Enhancement 3 in Table 2 at approximately a 2.3 dB lower signal to noise ratio (SNR). Similarly, NR enhancement 1 and NR enhancement 2 in Table 2 achieved the same 200 MbpS as NR Baseline 1, NR Baseline 2, and NR Enhancement 3 in Table 2 at approximately a 3.9 dB lower SNR, and NR enhancement 1 and NR enhancement 2 in Table 2 achieved the same 300 Mbps as NR Baseline 1, NR Baseline 2, and NR Enhancement 3 in Table 2 at approximately a 5.3 dB lower SNR. Accordingly, subband precoding for uplink MU-MIMO may achieve precoding gain over wideband precoding. Indicating a separate TPMI for each PRG, however, may involve significant signaling overhead.

In some examples, the network entity 105 may indicate, to a UE 115, a single TD uplink precoder across the PRGs to reduce the signaling overhead. The TD uplink precoder may be generated using subband precoding to achieve the gain associated with subband precoding. To reduce signaling overhead, the network entity 105 may indicate in an uplink grant (e.g., the DCI that schedules an uplink shared channel communication) less than all of the TD uplink precoder coefficients of the TD uplink precoder, and the network may indicate the indices (e.g., taps) of the TD uplink precoder that correspond to the included TD uplink precoder coefficients. The indicated TD uplink precoder coefficients may correspond to the strongest (e.g., the highest value) TD uplink precoder coefficients. Accordingly, when the UE transforms the TD uplink precoder to an FD precoder using the indicated TD uplink precoder coefficients (e.g., using an FFT), the resulting FD precoder may be approximate to the FD precoder that would be generated using all of the TD uplink precoder coefficients.

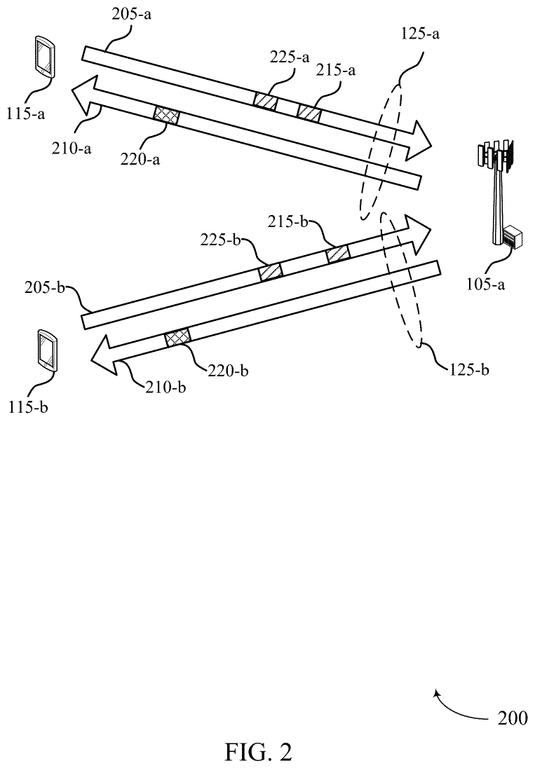

FIG. 2 shows an example of a wireless communications system 200 that supports two-stage time-domain uplink precoder indication in accordance with one or more aspects of the present disclosure. The wireless communications system 200 may implement or may be implemented by aspects of the wireless communications system 100. For example, the wireless communications system 200 includes a UE 115-a, a UE 115-b, and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. The network entity 105-a may communicate with the UE 115-b via a communication link 125-b, which may be an example of an NR or LTE link between the UE 115-b and the network entity 105-a. In some cases, the communication link 125-a and the communication link 125-b may include examples of an access link (e.g., a Uu link). The communication link 125-a and the communication link 125-b may each include a bi-directional link that enables both uplink and downlink communication. For example, the UE 115-a may transmit uplink signals 205-a, such as uplink control signals or uplink data signals, to the network entity 105-a using the communication link 125-a, and the network entity 105-a may transmit downlink signals 210-a, such as downlink control signals or downlink data signals, to the UE 115-a using the communication link 125-a. The UE 115-b may transmit uplink signals 205-b, such as uplink control signals or uplink data signals, to the network entity 105-a using the communication link 125-b, and the network entity 105-a may transmit downlink signals 210-b, such as downlink control signals or downlink data signals, to the UE 115-b using the communication link 125-b.

In some uplink massive MIMO setups, open-loop precoding may provide sufficient gain given that the quantity of receive ports at the network entity 105-a may be larger (e.g., much larger) than the quantity of transmission layers. For example, the network entity 105-a may spatially demap the layers solely by receive processing in such examples. The quantity of receive antennas at the network entity 105-a may not be large, however, in some cases. For example, some network entity vendors may not upgrade infrastructure to increase the quantity of receive antennas, especially in FDD scenarios. In some examples, the network entity 105-a may schedule UEs 115 that are spatially separable simultaneously, which may be referred to as smart UE scheduling. Smart UE scheduling, however, may not be feasible in scenarios where the network entity 105-a serves a large quantity of UEs 115.

Accordingly, as described herein, the network entity 105-a may coordinate precoders across UEs 115 (e.g., including the UE 115-a and the UE 115-b) to minimize inter-UE interference for simultaneous transmissions from the UEs 115. For example, the network entity 105-a may implement join uplink MU-MIMO precoding in FDD.

As described herein, in uplink MU-MIMO, the network entity 105-a may jointly design precoders across multiple UEs 115 (e.g., including the UE 115-a and the UE 115-b) for simultaneous uplink transmissions 225 by the multiple UEs 115 to the network entity 105. The UEs 115 may transmit sounding reference signals (SRSs) 215 using one or more beams, (e.g., using beam-sweeping techniques) as described herein. The network entity 105-a may obtain full channel knowledge of the channels between the UEs 115 and the network entity 105-a based on measurements of the SRSs. For example, the network entity 105-a may design precoders for the UEs 115 based on measurements of the SRSs 215. The network entity 105-a may provide uplink grants 220 (e.g., via DCI) to the UEs 115 scheduling the uplink transmissions 225, and the uplink grants 220 may indicate the respective precoder designed for each UE 115. For example, the UE 115-a may transmit SRSs 215-a, and the UE 115-b may transmit SRSs 215-b. The network entity 105-a may measure the SRS 215-a and the SRSs 215-b, and the network entity 105-a may design precoders for MU-MIMO uplink transmissions from the UE 115-a and the UE 115-b. Although shown as two UEs 115, the network entity 105-a may design precoders for any quantity of UEs 115 that will participate in an MU-MIMO uplink transmission. The network entity 105-a may provide an uplink grant 220-a to the UE 115-a that indicates scheduling information for an uplink transmission 225-a. The uplink grant 220-a may indicate the precoder for the UE 115-a to use for the uplink transmission 225-a. The network entity 105-a may provide an uplink grant 220-b to the UE 115-b that indicates scheduling information for an uplink transmission 225-b. The uplink grant 220-b may indicate the precoder for the UE 115-a to use for the uplink transmission 225-b. The UE 115-a may perform the uplink transmission 225-a using the precoder indicated in the uplink grant 220-a, and the UE 115-b may perform the uplink transmission 225-b using the precoder indicated in the uplink grant 220-b.

As described herein, indication of a separate TPMI for each PRG may involve significant signaling overhead and/or may not be available in DCI formats. For example, a per PRG subband TPMI indication may lead to an excessive signaling overhead. For example, assuming that there are 52 PRGs and 28 TMPIs (e.g., 5 bits may be used to indicate the TPMI), a per subband TPMI indication may involve 52×5=260 bits to indicate which of the 28 TPMIs to use across the 52 PRGs in the uplink grant. Accordingly, aspects of this disclosure involve use of a single TD uplink precoder (e.g., in the uplink grant 220) across the PRGs for an uplink transmission to reduce the signaling overhead. In some examples, the network entity 105-a may indicate (e.g., in the uplink grants 220 or a separate control message such as a MAC-CE), the indices (e.g., taps) of the TD uplink precoder that will be indicated in an uplink grant, and the uplink grants 220 may include the TD uplink precoder coefficients that correspond to the indicated indices. The indicated TD uplink precoder coefficients may correspond to the strongest (e.g., the highest value) TD uplink precoder coefficients. Accordingly, when the UEs 115 transforms the TD uplink precoder to an FD precoder using the indicated TD uplink precoder coefficients (e.g., using an FFT) the resulting FD uplink precoder may be approximate to the FD uplink precoder that would be generated using all of the TD uplink precoder coefficients.

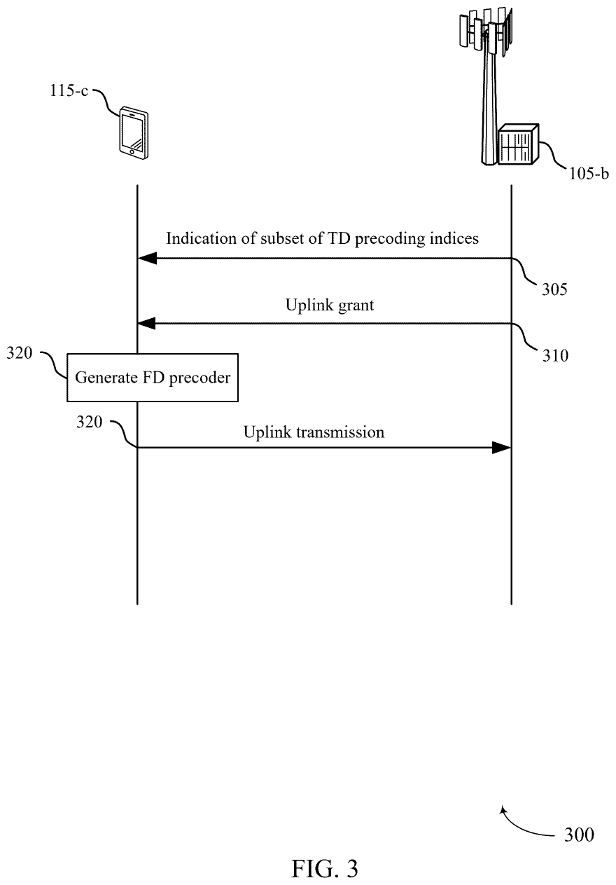

FIG. 3 shows an example of a process flow 300 that supports two-stage time-domain uplink precoder indication in accordance with one or more aspects of the present disclosure. The process flow 300 may include a UE 115-c and a network entity 105-b, which may be examples of a UE 115 and a network entity 105 as described herein. In the following description of the process flow 300, the communications between the network entity 105-b and the UE 115-c may be transmitted in a different order than the example order shown, or the operations performed by the network entity 105-b and the UE 115-c may be performed in different orders or at different times. Some operations may also be omitted from the process flow 300, and other operations may be added to the process flow 300.

The process flow 300 may illustrate an example TD uplink precoder indication scheme where the network entity 105-b may indicate to the UE 115-c a single TD uplink precoder across the PRGs of an uplink transmission scheduled by an uplink grant to reduce the signaling overhead in the uplink grant associated with indication of the uplink precoder using subband precoding.

For example, at 305, the network entity 105-b may indicate (e.g., via an uplink grant or other control signaling such as a MAC-CE) a subset of TD uplink precoder indices (e.g., the locations of the strongest taps) of a set of multiple TD uplink precoder indices (e.g., multiple taps) associated with a communication channel between the UE and the network entity. For example, the quantity of TD uplink precoder indices of the set of multiple TD uplink precoder indices may be equal to a quantity of PRGs of the communication channel between the UE 115-c and the network entity 105-b. For example, the indicated TD uplink precoder indices may be {n=0, n=1, n=2, n=7} from the set of precoder indices {n=0, n=1, n=2, n=3, n=4, n=5, n=6, n=7, n=8, n=9}.

At 310, the network entity 105-b may indicate (e.g., via the uplink grant that schedules an uplink transmission), the TD uplink precoder coefficients for the indicated subset of TD uplink precoder indices (e.g., Wₜ[0]=A, Wₜ[1]=B, Wₜ[2]=C, Wₜ[7]=D). In some examples, the indication of the subset of TD uplink precoder indices (e.g., at 305) may be included in the same control message as the uplink grant at 310. In some examples, the channel (e.g., the physical downlink control channel (PDCCH)) that carries the uplink grant may have a limited payload. Accordingly, in some examples, the indication of the subset of TD uplink precoder indices (e.g., at 305) may be via other control signaling (e.g., via other layer 2 signaling such as a MAC-CE or layer 1 signaling such as another DCI).

At 315, the UE 115-c may generate an FD uplink precoder based on the indicated TD uplink precoder coefficients and the corresponding TD uplink precoder indices. For example, the UE 115-c may apply an FFT to a TD uplink precoder based on the TD uplink precoder coefficients provided by the network entity 105-b in the uplink grant. For example, the UE 115-b may apply a zero-value coefficient for a remainder of the TD uplink precoder indices other than the indicated subset of TD uplink precoder indices to generate the TD uplink precoder, and may apply the FFT to the generated TD uplink precoder to generate an FD precoder.

At 320, the UE 115-c may perform the uplink transmission (e.g., a PUSCH transmission) scheduled by the uplink grant at 310 in accordance with the generated FD precoder.

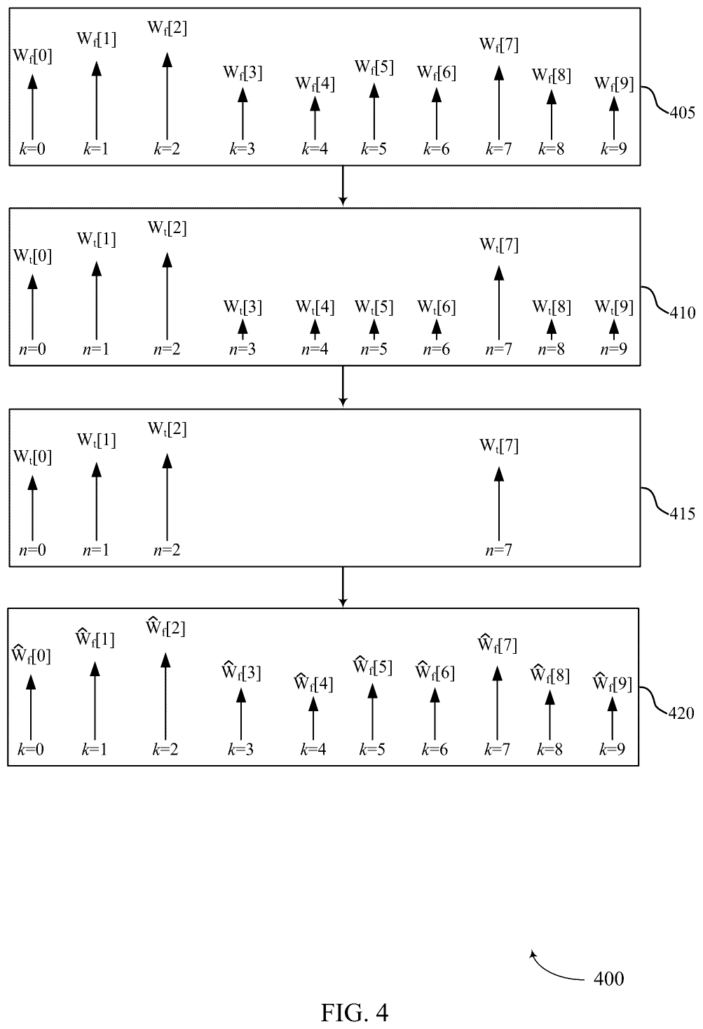

FIG. 4 shows an example of a precoder flow diagram 400 that supports two-stage time-domain uplink precoder indication in accordance with one or more aspects of the present disclosure. The precoder flow diagram 400 may implement or may be implemented by aspects of the wireless communications system 100, the wireless communications system 200, and/or the process flow 300. For example, the precoder flow diagram 400 shows an example method that may be used by a network entity 105 and a UE 115 for the network entity 105 to indicate a single TD uplink precoder across multiple PRGs via indication of a subset of TD uplink precoder indices. For example, as described herein, instead of conveying the FD uplink precoder for each PRG (which may involve high signaling overhead), the network entity 105 may indicate to the UE 115 a single TD uplink precoder across multiple PRGs via indicating the strongest (e.g., the quantity s TD uplink precoders indices having the highest value based on measurements of SRSs from the UE 115) TD uplink precoder indices (e.g., taps) and the TD uplink precoder coefficients for those TD uplink precoder indices.

At 405, the network entity 105 may compute the FD uplink precoder W_{f}[k] for the k-th PRG for each k=0, . . . , K−1. In the example of FIG. 4, K=10, but the techniques of FIG. 4 may be applied to any quantity of PRGs.

At 410, the network entity 105 may transform the FD uplink precoder into a TD uplink precoder via application of an inverse FFT (IFFT) to the FD uplink precoder computed at 405. For example, the TD uplink precoder, Wₜ[n], may be given by

$${W}_{t} [ n ] = 1 / K \times {\sum }_{k = 1}^{K} {W}_{f} [ k ] {e}^{j 2 π kn / K}$$

for each n=0, . . . , K−1.

At 415, the network entity 105 may indicate, to the UE 115, the top-s strongest TD uplink precoder indices (e.g., taps) and the TD uplink precoder coefficients for those TD uplink precoder indices. For example, the TD uplink precoder generated by the UE 115 may be given by equation 1:

$${\hat{W}}_{t} [ n ] = \{ \begin{matrix}{W}_{t} [ n ] & ( n is one of the top - s strongest taps ) \\ 0 & ( otherwise )\end{matrix} \qquad ( 1 )$$

For example, as shown, the network entity 105 may indicate the TD uplink precoder indices {n=0, n=1, n=2, n=7} from the set of precoder indices {n=0, n=1, n=2, n=3, n=4, n=5, n=6, n=7, n=8, n=9} and the TD uplink precoder coefficients for the TD uplink precoder indices {n=0, n=1, n=2, n=7}, {Wₜ[0], Wₜ[1], Wₜ[2], Wₜ[7]}.

At 420, the UE 115 may transform the TD uplink precoder, Ŵₜ[n], into the FD uplink precoder, Ŵ_{f}[k] via application of an FFT. For example, the FD uplink precoder, Ŵ_{f}[k], may be given by

$${\hat{W}}_{f} [ k ] = {\sum }_{n = 1}^{K} {\hat{W}}_{t} [ n ] {e}^{- j 2 π kn / K}$$

for each k=0, . . . , K−1.

Indication of the TD precoding coefficients for only the top-s strongest TD uplink precoder indices may reduce signaling overhead as compared to indication of the TD uplink precoder coefficients for each of the TD uplink precoder indices or to indication of the FD precoder per PRG. As shown, if the TD uplink precoder is sparse (e.g., as shown in FIG. 4 where the values of Wₜ[3], Wₜ[4], Wₜ[5], Wₜ[6], Wₜ[7], and Wₜ[8] are low in comparison to the values of Wₜ[0], Wₜ[1], Wₜ[2], Wₜ[7], the FD uplink precoder recovered by the UE 115 at 420 may approximate the FD uplink precoder computed by the network entity 105 at 405 (e.g., the FD uplink precoder computed by the network entity 105 at 405 may be accurately recovered by the UE 115).

In FIG. 4, W_{f}[k]∈ [symbol] =FD uplink precoder for the k-th PRG, and Wₜ[n]∈ [symbol] =TD UL precoder for the n-th TD uplink precoder index (e.g., tap).

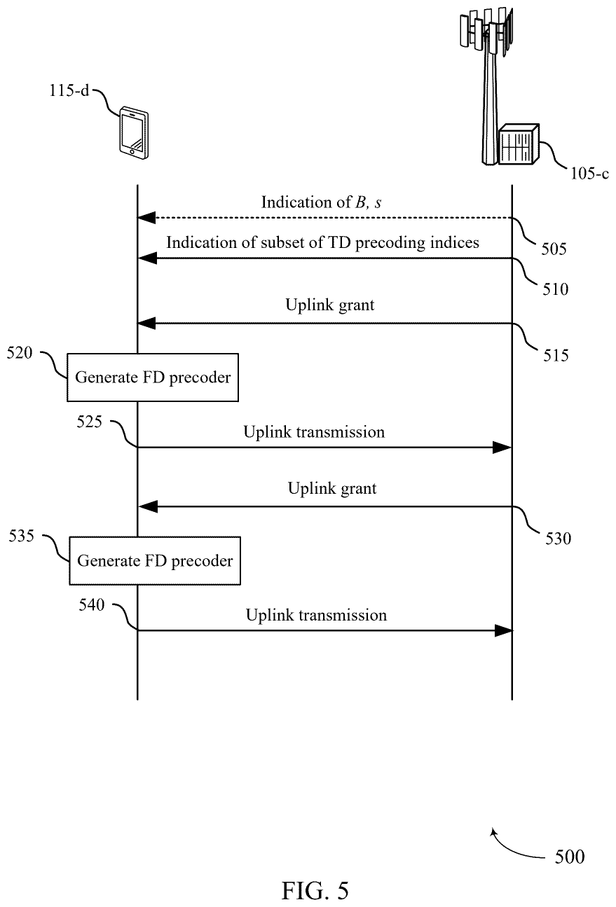

FIG. 5 shows an example of a process flow 500 that supports two-stage time-domain uplink precoder indication in accordance with one or more aspects of the present disclosure. The process flow 500 may include a UE 115-d and a network entity 105-c, which may be examples of a UE 115 and a network entity 105 as described herein. In the following description of the process flow 500, the communications between the network entity 105-c and the UE 115-d may be transmitted in a different order than the example order shown, or the operations performed by the network entity 105-c and the UE 115-d may be performed in different orders or at different times. Some operations may also be omitted from the process flow 500, and other operations may be added to the process flow 500.

The locations of the strongest TD uplink precoder indices for the UE 115-d may remain constant over a longer period of time than the TD uplink precoder coefficients, for example, depending on the mobility of the UE 115-d. Accordingly, in some examples, as shown in the process flow 500, the network entity 105-c may indicate, to the UE 115-d, the locations of the strongest TD uplink precoder indices (e.g., that may vary slowly) in a first control message (e.g., in a MAC-CE over layer 2). The network entity 105-c may indicate the TD uplink precoder coefficients for those previously indicated TD uplink precoder indices, which TD uplink precoder coefficients may vary more rapidly, in the uplink grant for a particular uplink transmission (e.g., in DCI over layer 1 signaling). Such a two-part indication of the locations of the strongest TD uplink precoder indices and the corresponding TD uplink precoder coefficients may reduce signaling overhead in an uplink grant (e.g., as compared to indicating the strongest TD uplink precoder indices in the uplink grant).

For example, at 510, the network entity 105-c may transmit a first control message that indicates a subset of TD precoding indices (e.g., that indicates the top-s strongest TD precoding indices based on measurements of SRSs transmitted by the UE 115-d). For example, the first control message may be a MAC-CE. For example, the indicated TD uplink precoder indices in the first control message may be {n=0, n=1, n=2, n=7} from the set of precoder indices {n=0, n=1, n=2, n=3, n=4, n=5, n=6, n=7, n=8, n=9}.

At 515, the network entity 105-c may provide a first uplink grant (e.g., via a DCI) that may indicate scheduling information for a first uplink transmission (e.g., a first PUSCH transmission) and the TD uplink precoder coefficients for the subset of TD precoding indices (e.g., Wₜ[0]=A, Wₜ[1]=B, Wₜ[2]=C, Wₜ[7]=D).

At 520, the UE 115-c may generate an FD uplink precoder for the first uplink transmission based on the indicated TD uplink precoder coefficients (e.g., Wₜ[0]=A, Wₜ[1]=B, Wₜ[2]=C, Wₜ[7]=D) and the corresponding TD uplink precoder indices (e.g., {n=0, n=1, n=2, n=7}).

At 525, the UE 115-c may perform the uplink transmission (e.g., a PUSCH transmission) scheduled by the uplink grant at 515 in accordance with the generated FD precoder.

At 530, the network entity 105-c may transmit a second uplink grant (e.g., via a DCI) that may indicate scheduling information for a second uplink transmission (e.g., a second PUSCH transmission) and the TD uplink precoder coefficients for the subset of TD precoding indices (e.g., Wₜ[0]=E, Wₜ[1]=F, Wₜ[2]=G, Wₜ[7]=H).

At 535, the UE 115-c may generate an FD uplink precoder for the second uplink transmission based on the indicated TD uplink precoder coefficients (e.g., Wₜ[0]=E, Wₜ[1]=F, Wₜ[2]=G, Wₜ[7]=H) and the corresponding TD uplink precoder indices (e.g., {n=0, n=1, n=2, n=7}).

At 540, the UE 115-c may perform the uplink transmission (e.g., a PUSCH transmission) scheduled by the uplink grant at 530 in accordance with the generated FD precoder.

As described herein, a MAC-CE may indicate (e.g., at 510), the subset of TD uplink precoder indices (e.g., the top-s strongest TD uplink precoder indices). As described herein, an uplink grant (e.g., at 515 and 530) may indicate the TD uplink precoder coefficients that correspond to the previously indicated subset of TD uplink precoder indices.

In some examples, to indicate the TD uplink precoder coefficient for a particular TD uplink precoder index, the network entity 105-c may indicate (e.g., in the uplink grant), the raw TD uplink precoder coefficient, for example, via quantizing the amplitude and phase of each element. For example, the network entity 105-c may indicate Q(Wₜ[n]) for the n^{th} TD uplink precoder index, where Q may refer to the quantizing the amplitude and phase of Wₜ[n]. For example, considering a TD uplink precoder coefficient for a particular TD uplink precoder coefficient (e.g., (quantity of ports)-by-(quantity of layers) complex matrix), if the network entity 105-c quantizes each element of the (quantity of ports)-by-(quantity of layers) complex matrix by Bₛ bits, the signaling overhead may be given by Bₛ×(quantity of ports)× (quantity of layers)×s bits in the uplink grant when conveying only the top-s strongest TD uplink precoder indices.

In some examples, to indicate the TD uplink precoder coefficient for a particular TD uplink precoder index, the network entity may indicate the TPMI corresponding to the codeword nearest the TD uplink precoder coefficient in order to reduce the signaling overhead in the uplink grant. For example, the network entity 105-c may indicate a Bᵥ-bit TPMI for the n^{th} TD uplink precoder index, where the Bᵥ-bit

$$TPMI = {}_{{B}_{v} ∈ \{ 0 , ... , {2}^{{B}_{v}} - 1 )}^{argmax} {‖ {c}_{{B}_{v}} - {W}_{t} [ n ] ‖}^{2} .$$

For example, considering a codebook of size Bᵥ, which may contain 2^{B}^{ᵥ} possible TD uplink precoder coefficients, since the Bᵥ-bit TPMI represents the TD uplink precoder coefficient, the signaling overhead may be Bᵥ×s bits in the uplink grant when conveying the top-s strongest TD uplink precoder indices. For example, the NR PUSCH codebook (e.g., which may be used for compressing the WB FD uplink precoder) or a new codebook may be used to indicate the TD uplink precoder coefficient for a particular TD uplink precoder index. Indication of the raw TD uplink precoder coefficient may be associated with a larger signaling overhead in the uplink grant in some examples that indication via indication of the TPMI corresponding to the codeword nearest the TD uplink precoder coefficient.

The quantity of bits, B, to represent the TD uplink precoder coefficient for a particular TD uplink precoder index and the quantity of TD uplink precoder indices, s, in the subset of TD uplink precoder indices may depend on the quantity of ports (e., receive ports at the network entity 105-c) and the quantity of layers (e.g., transmitted across the multiple UEs 115 in a MU-MIMO transmission). Thus, how to interpret the field in the uplink grant (e.g., at 515 and/or 530) that indicates the TD uplink precoder coefficients may depend on the quantity of ports and the quantity of layers. Accordingly, in some examples, the network entity 105-a may indicate the quantities of B and s for different (e.g., for each) combination of quantities of ports and layers.

For example, the network entity 105-a may transmit signaling at 505 (e.g., RRC signaling), indicating a valid (B, s) for each (quantity of ports, quantity of layers) where B is the quantity of bits to represent the TD uplink precoder coefficient for a particular TD uplink precoder index and s is the quantity of TD uplink precoder indices in the subset that the network entity 105-a indicates at 510. Similarly, with reference to FIG. 3, the network entity 105-b may provide (e.g., via RRC signaling), the valid (B, s) for each (quantity of ports, quantity of layers).

For example, the signaling at 505 may configure example values of (B, s) for each (quantity of ports, quantity of layers) as shown in Table 3.

TABLE 3

| | | Quantity of bits in uplink grant to |
|---|---|---|
| | | indicate the TD uplink precoder |
| (Quantity of ports, | | coefficients for the top-s TD uplink |
| Quantity of layers) | (B, s) | precoder indices |
| (2, 1) | (3, 6) | 18 |
| (4, 1) | (5, 4) | 20 |
| (2, 2) | (2, 10) | 20 |
| (4, 2) | (5, 4) | 20 |
| (4, 3) | (3, 6) | 18 |
| (4, 4) | (3, 6) | 18 |

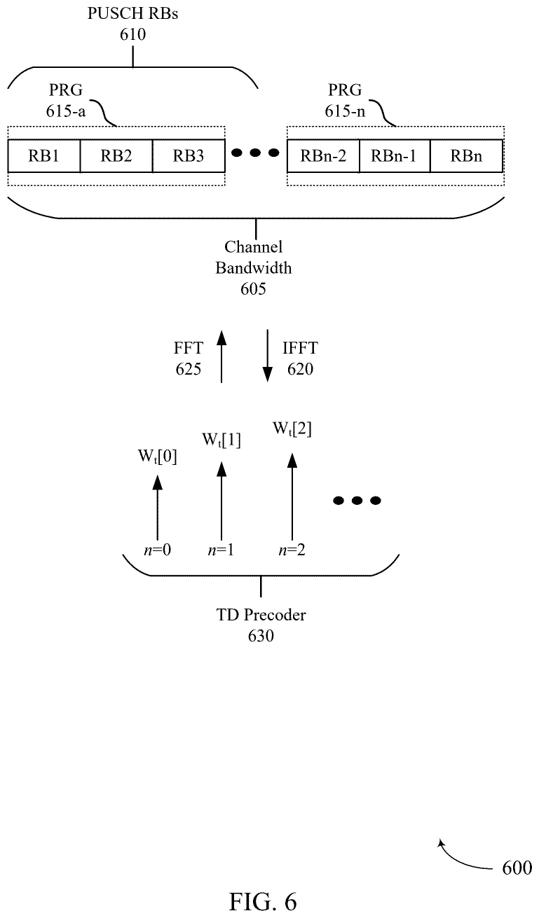

FIG. 6 shows an example of a resource and precoder diagram 600 that supports two-stage time-domain uplink precoder indication in accordance with one or more aspects of the present disclosure. The resource and precoder diagram 600 may implement or may be implemented by aspects of the wireless communications system 100, the wireless communications system 200, the precoder flow diagram 400, and/or the process flow 500.

As described herein, in some examples, a network entity 105 may provide, to a UE 115, an indication in first control message (e.g., a MAC-CE) of a subset of TD uplink precoder indices from a set of multiple TD uplink precoder indices associated with a communication channel bandwidth 605 between the UE 115 and the network entity 105. The network entity 105 may provide an uplink grant via a second control message (e.g., via a DCI) to the UE 115 that schedules an uplink transmission for the UE 115, and the uplink grant may indicate TD uplink precoder coefficients that correspond to the subset of TD uplink precoder indices.

For example, the network entity 105 may compute the FD uplink precoder for each PRG 615 across RBs of interest 610 (e.g., RBs that will be used for a PUSCH). For example, the RBs of interest 610 may include the PRG 615-a but may not include a PRG 615-n. For example, the RBs of interest 610 may be selected from RBs which were sounded via SRSs transmitted by the UE 115. The network entity 105 may select the RBs of interest based on scheduling decisions (e.g., for multiplexing multiple UEs across the FD) or based on precoder computations. The network entity 105 may transform the computed FD uplink precoder into a TD uplink precoder 630 via application of an IFFT 620.

The network entity 105 may transmit the first control message which may indicate the locations of the strongest TD uplink precoder indices of the TD uplink precoder (e.g., the subset of TD uplink precoder indices from a set of multiple TD uplink precoder indices). In some examples, the first control message may indicate the RBs of interest 610 (e.g., the RBs across which the FD uplink precoder was computed or indicated) and/or may indicate the PRG level (e.g., the quantity of RBs in each PRG). In the example of FIG. 6, the PRG level is 3. The first control message may indicate the PRG level and the RBs of interest 610 as the quantity of PRGs within the RBs of interest 610 may determine the size of the FFT 625 the UE 115 may use to generate the FD uplink precoder from the indicated TD uplink precoding coefficients (e.g., at 320 of FIG. 3, at 420 of FIG. 4, and at 520 and 535 of FIG. 5).

The uplink grant provided by the network entity 105 to the UE 115 after the first control message may indicate the TD uplink precoder coefficients that correspond to the subset of TD uplink precoder indices indicated in the first control message. The uplink grant may also schedule an uplink transmission. In some examples, the RBs across which the TD uplink precoder is indicated or computed may not coincide with the RBs across which the uplink transmission is scheduled. For example, the uplink transmission (e.g., the PUSCH) may be scheduled within RBs which the UE 115 sounded via SRSs.

The UE 115 may transform the TD uplink precoder into the FD uplink precoder via application of the FFT 625. The UE 115 may precode the uplink transmission (e.g., the PUSCH) using at least a portion of the FD uplink precoder that corresponds to the RBs across which the uplink transmission (e.g., the PUSCH) is scheduled.

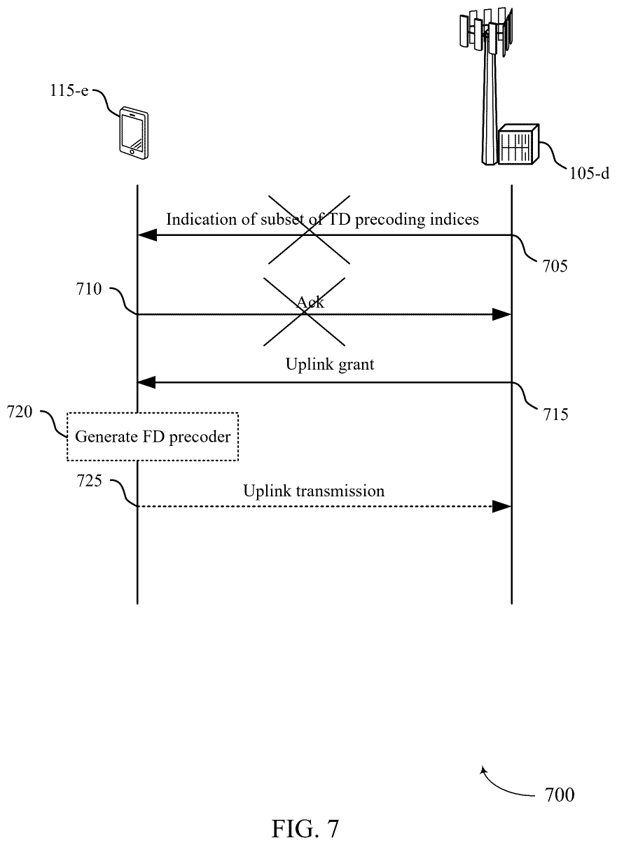

FIG. 7 shows an example of a process flow 700 that supports two-stage time-domain uplink precoder indication in accordance with one or more aspects of the present disclosure. The process flow 700 may include a UE 115-e and a network entity 105-d, which may be examples of a UE 115 and a network entity 105 as described herein. In the following description of the process flow 700, the communications between the network entity 105-d and the UE 115-e may be transmitted in a different order than the example order shown, or the operations performed by the network entity 105-d and the UE 115-e may be performed in different orders or at different times. Some operations may also be omitted from the process flow 700, and other operations may be added to the process flow 700.

As described herein, in some examples, the network entity 105-d may transmit a MAC-CE which may indicate a subset of TD uplink precoder indices from a set of multiple TD uplink precoder indices associated with a communication channel bandwidth 605 between the UE 115 and the network entity 105.

In some examples, however, the UE 115-e may not successfully receive the MAC-CE (e.g., or whichever control message is used to indicate the subset of TD uplink precoder indices). For example, the UE 115-e may not transmit an acknowledgment at 710 for the MAC-CE at 705.

In some examples, where the UE 115-e does not transmit an ACK at 710, the network entity 105-d may subsequently provide an uplink grant that schedules an uplink transmission and that provides TD uplink precoder coefficients.

In some such examples, the UE 115-e may use a previous (e.g., latest) indication of a subset of TD uplink precoder indices (e.g., from a prior MAC-CE which was successfully received and acknowledged) in order to generate an FD uplink precoder at 720. For example, if the previously acknowledged indication of the subset of TD uplink precoder indices is compatible with the uplink grant at 715 (e.g., the quantity of indicated TD uplink precoder indices (e.g., {n₁, . . . , nₛ}) and the quantity of TD uplink precoder coefficients in the uplink grant (e.g., {Wₜ[n₁], . . . , Wₜ[nₛ]}) are the same, and the uplink transmission is scheduled within the same set of RBs as the uplink precoder indicated in the previously acknowledged control message), then the UE 115-e may use the previously acknowledged indication of the subset of TD uplink precoder indices to generate the FD uplink precoder at 720. The UE 115-e may perform the uplink transmission at 725 in accordance with the FD uplink precoder generated at 725.

In some such examples, the UE 115-e may use a single TD uplink precoder index instead of using all of the TD uplink precoder indices in order to construct a wideband FD precoder at 720. In such examples, the UE 115-e may perform the uplink transmission at 725 in accordance with the wideband FD uplink precoder generated at 725.

In some such examples, the UE 115-e may ignore the uplink grant at 715. For example, the UE 115-e may refrain from transmitting an uplink transmission if the UE 115-e did not receive an indication of a subset of TD uplink precoder indices corresponding to the TD uplink precoder coefficients indicated in the uplink grant.

In some examples, where the UE 115-e did not receive an indication of a subset of TD uplink precoder indices corresponding to the TD uplink precoder coefficients indicated in the uplink grant, the UE 115-e at 725 may use a default or preconfigured FD uplink precoder for precoding the uplink transmission. For example, the default or preconfigured FD uplink precoder may be configured via RRC signaling as a fallback FD uplink precoder.

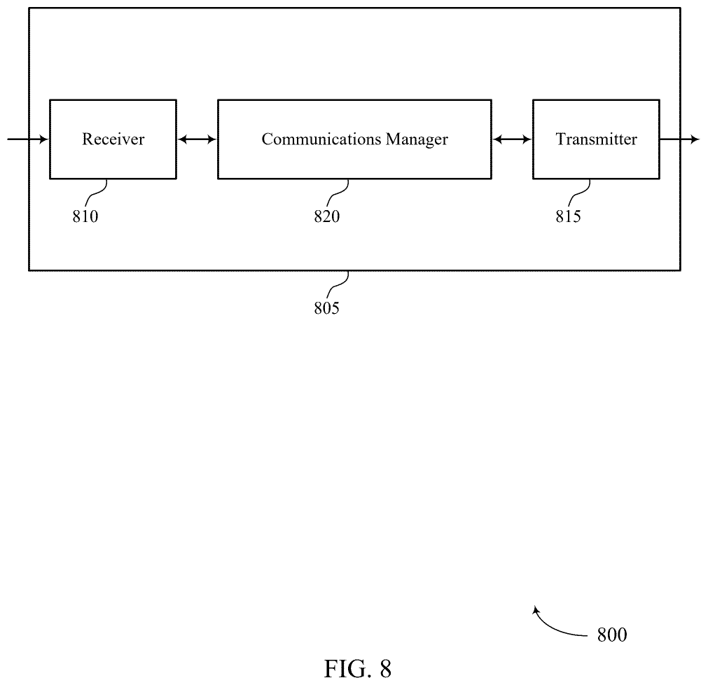

FIG. 8 shows a block diagram 800 of a device 805 that supports two-stage time-domain uplink precoder indication in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to two-stage time-domain uplink precoder indication). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to two-stage time-domain uplink precoder indication). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of two-stage time-domain uplink precoder indication as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel. The communications manager 820 is capable of, configured to, or operable to support a means for receiving, from the network entity, an uplink grant that schedules an uplink shared channel communication, where the uplink grant indicates a respective TD precoder coefficient for each of the subset of TD precoder indices. The communications manager 820 is capable of, configured to, or operable to support a means for generating an FD precoder for the uplink shared channel communication based on each respective TD precoder coefficient. The communications manager 820 is capable of, configured to, or operable to support a means for transmitting, to the network entity, the uplink shared channel communication precoded in accordance with the FD precoder.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing and more efficient utilization of communication resources.

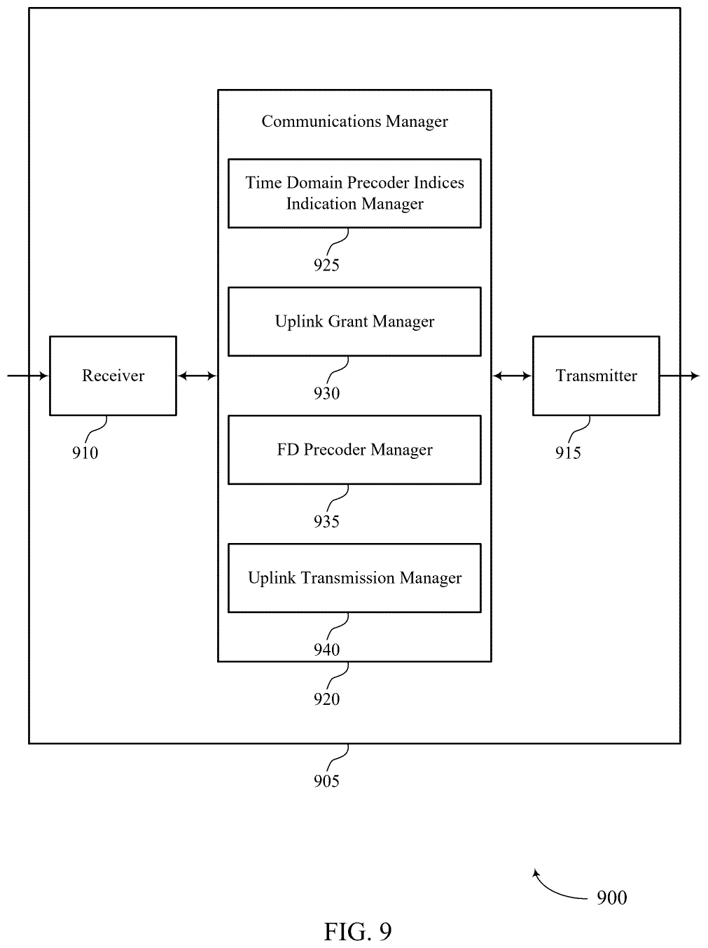

FIG. 9 shows a block diagram 900 of a device 905 that supports two-stage time-domain uplink precoder indication in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to two-stage time-domain uplink precoder indication). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to two-stage time-domain uplink precoder indication). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of two-stage time-domain uplink precoder indication as described herein. For example, the communications manager 920 may include a TD precoder indices indication manager 925, an uplink grant manager 930, an FD precoder manager 935, an uplink transmission manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The TD precoder indices indication manager 925 is capable of, configured to, or operable to support a means for receiving, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel. The uplink grant manager 930 is capable of, configured to, or operable to support a means for receiving, from the network entity, an uplink grant that schedules an uplink shared channel communication, where the uplink grant indicates a respective TD precoder coefficient for each of the subset of TD precoder indices. The FD precoder manager 935 is capable of, configured to, or operable to support a means for generating an FD precoder for the uplink shared channel communication based on each respective TD precoder coefficient. The uplink transmission manager 940 is capable of, configured to, or operable to support a means for transmitting, to the network entity, the uplink shared channel communication precoded in accordance with the FD precoder.

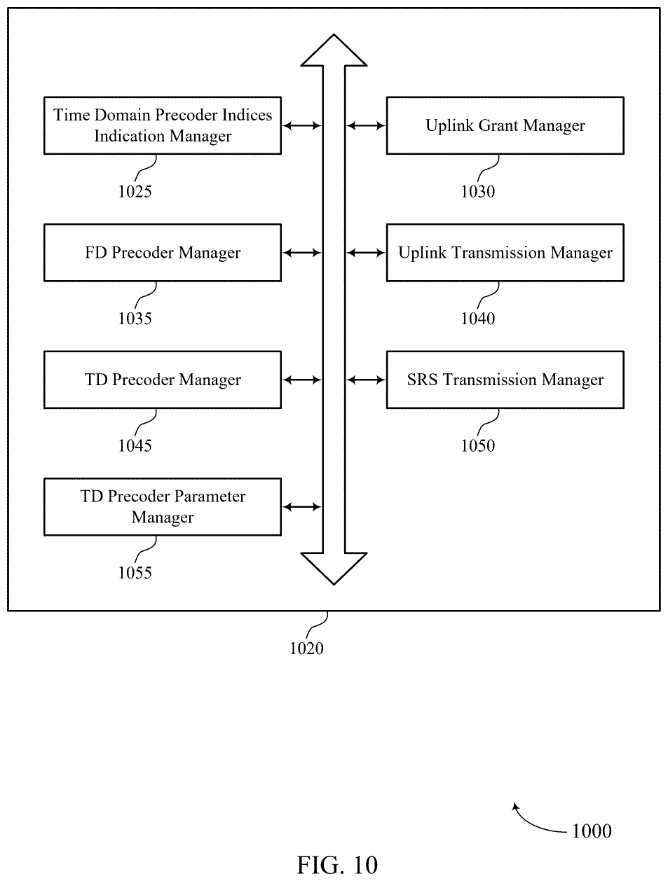

FIG. 10 shows a block diagram 1000 of a communications manager 1020 that supports two-stage time-domain uplink precoder indication in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of two-stage time-domain uplink precoder indication as described herein. For example, the communications manager 1020 may include a TD precoder indices indication manager 1025, an uplink grant manager 1030, an FD precoder manager 1035, an uplink transmission manager 1040, a TD precoder manager 1045, an SRS transmission manager 1050, a TD precoder parameter manager 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The TD precoder indices indication manager 1025 is capable of, configured to, or operable to support a means for receiving, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel. The uplink grant manager 1030 is capable of, configured to, or operable to support a means for receiving, from the network entity, an uplink grant that schedules an uplink shared channel communication, where the uplink grant indicates a respective TD precoder coefficient for each of the subset of TD precoder indices. The FD precoder manager 1035 is capable of, configured to, or operable to support a means for generating an FD precoder for the uplink shared channel communication based on each respective TD precoder coefficient. The uplink transmission manager 1040 is capable of, configured to, or operable to support a means for transmitting, to the network entity, the uplink shared channel communication precoded in accordance with the FD precoder.

In some examples, to support generating the FD precoder, the TD precoder manager 1045 is capable of, configured to, or operable to support a means for generating a TD precoder based on each respective TD precoder coefficients and based on a zero-value for a remainder of the set of multiple TD precoder indices that are not included in the subset of TD precoder indices. In some examples, to support generating the FD precoder, the FD precoder manager 1035 is capable of, configured to, or operable to support a means for applying a FFT to the TD precoder to generate the FD precoder.

In some examples, the indication of the subset of TD precoder indices is received via the uplink grant.

In some examples, the indication of the subset of TD precoder indices is received via a first control message. In some examples, the uplink grant is received via a second control message.

In some examples, the uplink grant manager 1030 is capable of, configured to, or operable to support a means for receiving, from the network entity, a second uplink grant via a third control message that schedules a second uplink shared channel communication, where the second uplink grant indicates a second respective TD precoder coefficient for each of the subset of TD precoder indices. In some examples, the FD precoder manager 1035 is capable of, configured to, or operable to support a means for generating a second FD precoder for the second uplink shared channel communication based on each second respective TD precoder coefficient. In some examples, the uplink transmission manager 1040 is capable of, configured to, or operable to support a means for transmitting, to the network entity, the second uplink shared channel communication precoded in accordance with the second FD precoder.

In some examples, generating the second FD precoder is based on the subset of TD precoder indices indicated in the third control message matching the subset of TD precoder indices in the first control message.

In some examples, the TD precoder parameter manager 1055 is capable of, configured to, or operable to support a means for receiving, via the first control message, information that indicates a quantity of RBs associated with the set of multiple TD precoder indices and a quantity of RBs per PRG.

In some examples, the uplink grant manager 1030 is capable of, configured to, or operable to support a means for receiving, from the network entity and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices. In some examples, the FD precoder manager 1035 is capable of, configured to, or operable to support a means for generating a second FD precoder for the second uplink shared channel communication based on only one second respective TD precoder coefficient based on an absence of reception of a fourth control message that indicates the second subset of TD precoder indices of the set of multiple TD precoder indices. In some examples, the uplink transmission manager 1040 is capable of, configured to, or operable to support a means for transmitting, to the network entity, the second uplink shared channel communication precoded in accordance with the second FD precoder.

In some examples, the uplink grant manager 1030 is capable of, configured to, or operable to support a means for receiving, from the network entity and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices. In some examples, the TD precoder indices indication manager 1025 is capable of, configured to, or operable to support a means for refraining from transmitting the second uplink shared channel communication based on an absence of reception of a fourth control message that indicates the second subset of TD precoder indices of the set of multiple TD precoder indices.

In some examples, the uplink grant manager 1030 is capable of, configured to, or operable to support a means for receiving, from the network entity and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices. In some examples, the uplink transmission manager 1040 is capable of, configured to, or operable to support a means for transmitting, to the network entity, the second uplink shared channel communication precoded in accordance with a default FD precoder based on an absence of reception of a fourth control message that indicates the second subset of TD precoder indices of the set of multiple TD precoder indices.

In some examples, the TD precoder parameter manager 1055 is capable of, configured to, or operable to support a means for receiving, from the network entity, a third control message that indicates a quantity of TD precoder indices in the TD precoder indices, where the third control message further indicates a quantity of bits to use for indication of each respective TD precoder coefficient, where reception of the first control message and the second control message is based on reception of the third control message.

In some examples, the uplink grant indicates the respective TD precoder coefficient for each of the subset of TD precoder indices via indication of a respective quantized phase and amplitude for each of the subset of TD precoder indices.

In some examples, the uplink grant indicates the respective TD precoder coefficient for each of the subset of TD precoder indices via indication of a respective codeword from a codebook for each of the subset of TD precoder indices.

In some examples, the SRS transmission manager 1050 is capable of, configured to, or operable to support a means for transmitting a set of multiple sounding reference signals via the communication channel, where reception of the indication of the subset of TD precoder indices is based on transmission of the set of multiple sounding reference signals.

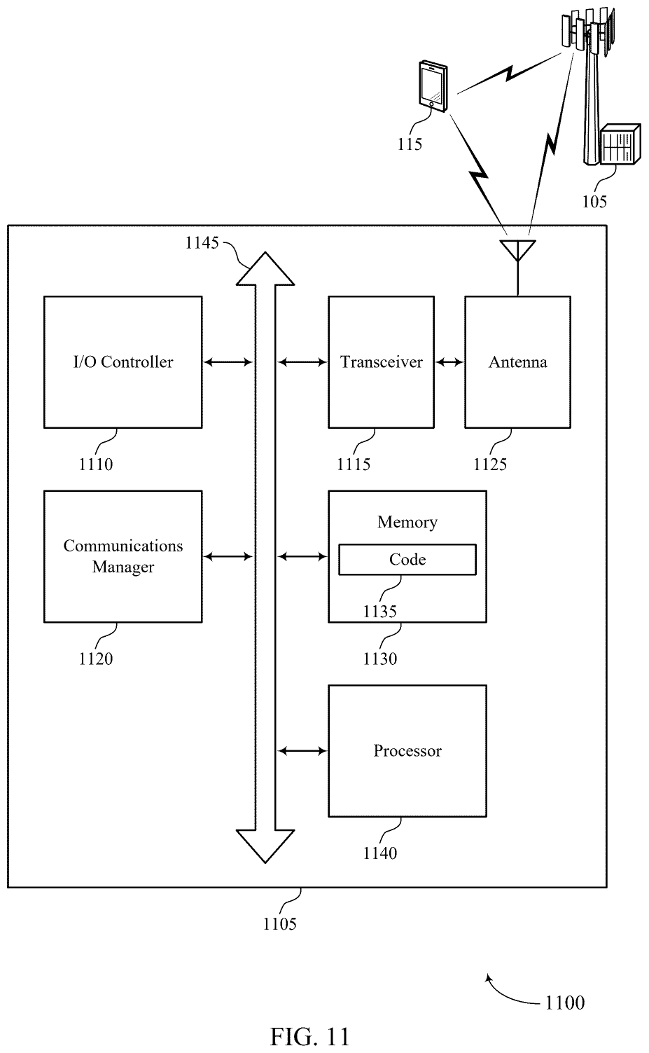

FIG. 11 shows a diagram of a system 1100 including a device 1105 that supports two-stage time-domain uplink precoder indication in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting two-stage time-domain uplink precoder indication). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel. The communications manager 1120 is capable of, configured to, or operable to support a means for receiving, from the network entity, an uplink grant that schedules an uplink shared channel communication, where the uplink grant indicates a respective TD precoder coefficient for each of the subset of TD precoder indices. The communications manager 1120 is capable of, configured to, or operable to support a means for generating an FD precoder for the uplink shared channel communication based on each respective TD precoder coefficient. The communications manager 1120 is capable of, configured to, or operable to support a means for transmitting, to the network entity, the uplink shared channel communication precoded in accordance with the FD precoder.

By including or configuring the communications manager 1120 in accordance with examples as described herein, the device 1105 may support techniques for more efficient utilization of communication resources, improved coordination between devices, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of two-stage time-domain uplink precoder indication as described herein, or the at least one processor 1140 and the at least one memory 1130 may be otherwise configured to, individually or collectively, perform or support such operations.

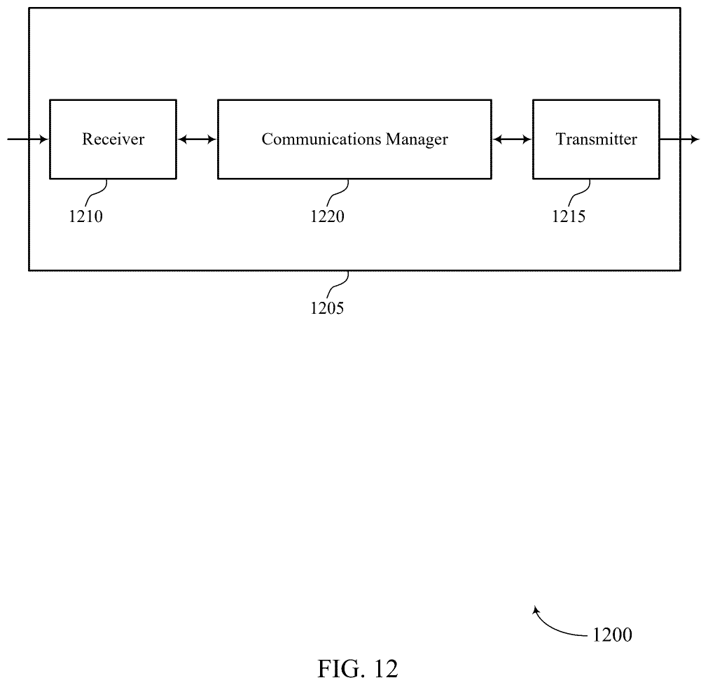

FIG. 12 shows a block diagram 1200 of a device 1205 that supports two-stage time-domain uplink precoder indication in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of two-stage time-domain uplink precoder indication as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel. The communications manager 1220 is capable of, configured to, or operable to support a means for transmitting, to the UE, an uplink grant that schedules an uplink shared channel communication, where the uplink grant indicates a respective TD precoder coefficient for each of the subset of TD precoder indices. The communications manager 1220 is capable of, configured to, or operable to support a means for receiving, from the UE, the uplink shared channel communication precoded in accordance with an FD precoder based on the respective TD precoder coefficient.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing and more efficient utilization of communication resources.

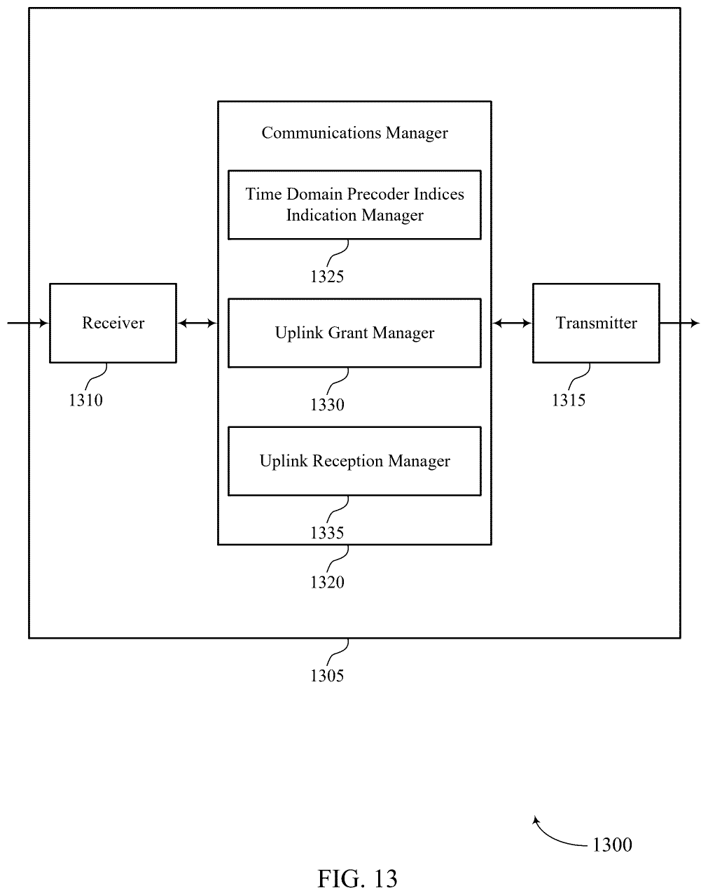

FIG. 13 shows a block diagram 1300 of a device 1305 that supports two-stage time-domain uplink precoder indication in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of two-stage time-domain uplink precoder indication as described herein. For example, the communications manager 1320 may include a TD precoder indices indication manager 1325, an uplink grant manager 1330, an uplink reception manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The TD precoder indices indication manager 1325 is capable of, configured to, or operable to support a means for transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel. The uplink grant manager 1330 is capable of, configured to, or operable to support a means for transmitting, to the UE, an uplink grant that schedules an uplink shared channel communication, where the uplink grant indicates a respective TD precoder coefficient for each of the subset of TD precoder indices. The uplink reception manager 1335 is capable of, configured to, or operable to support a means for receiving, from the UE, the uplink shared channel communication precoded in accordance with an FD precoder based on each respective TD precoder coefficient.

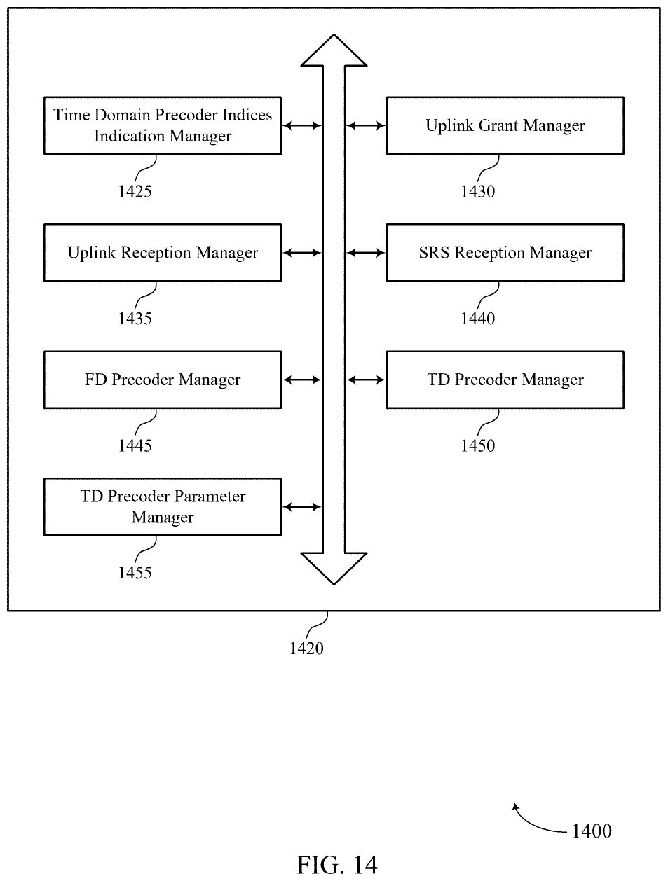

FIG. 14 shows a block diagram 1400 of a communications manager 1420 that supports two-stage time-domain uplink precoder indication in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of two-stage time-domain uplink precoder indication as described herein. For example, the communications manager 1420 may include a TD precoder indices indication manager 1425, an uplink grant manager 1430, an uplink reception manager 1435, an SRS reception manager 1440, an FD precoder manager 1445, a TD precoder manager 1450, a TD precoder parameter manager 1455, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The TD precoder indices indication manager 1425 is capable of, configured to, or operable to support a means for transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel. The uplink grant manager 1430 is capable of, configured to, or operable to support a means for transmitting, to the UE, an uplink grant that schedules an uplink shared channel communication, where the uplink grant indicates a respective TD precoder coefficient for each of the subset of TD precoder indices. The uplink reception manager 1435 is capable of, configured to, or operable to support a means for receiving, from the UE, the uplink shared channel communication precoded in accordance with an FD precoder based on each respective TD precoder coefficient.

In some examples, the SRS reception manager 1440 is capable of, configured to, or operable to support a means for receiving, from the UE, a set of multiple sounding reference signals via the communication channel. In some examples, the FD precoder manager 1445 is capable of, configured to, or operable to support a means for generating the FD precoder based on the set of multiple sounding reference signals. In some examples, the TD precoder manager 1450 is capable of, configured to, or operable to support a means for generating a TD precoder based on the FD precoder, the TD precoder including a respective TD precoder coefficient for each of the set of multiple TD precoder indices. In some examples, the TD precoder manager 1450 is capable of, configured to, or operable to support a means for selecting the subset of TD precoder indices from the set of multiple TD precoder indices based on the respective TD precoder coefficient for the subset of TD precoder indices satisfying a threshold.

In some examples, to support generating the TD precoder, the TD precoder manager 1450 is capable of, configured to, or operable to support a means for applying an inverse FFT to the FD precoder to generate the TD precoder.

In some examples, the indication of the subset of TD precoder indices is received via the uplink grant.

In some examples, the indication of the subset of TD precoder indices is received via a first control message. In some examples, the uplink grant is received via a second control message.

In some examples, the uplink grant manager 1430 is capable of, configured to, or operable to support a means for transmitting, to the UE, a second uplink grant via a third control message that schedules a second uplink shared channel communication, where the second uplink grant indicates a second respective TD precoder coefficient for each of the subset of TD precoder indices. In some examples, the uplink reception manager 1435 is capable of, configured to, or operable to support a means for receiving, from the UE, the second uplink shared channel communication in accordance with a second FD precoder based on each second respective TD precoder coefficient.

In some examples, receiving the second uplink shared channel communication in accordance with the second FD precoder is based on the subset of TD precoder indices indicated in the third control message matching the subset of TD precoder indices in the first control message.

In some examples, the TD precoder parameter manager 1455 is capable of, configured to, or operable to support a means for transmitting, via the first control message, information that indicates a quantity of RBs associated with the set of multiple TD precoder indices and a quantity of RBs per PRG.

In some examples, the uplink grant manager 1430 is capable of, configured to, or operable to support a means for transmitting, to the UE and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices. In some examples, the uplink reception manager 1435 is capable of, configured to, or operable to support a means for receiving, from the UE, the second uplink shared channel communication in accordance with a second FD precoder based on only one second respective TD precoder coefficient based on an absence of transmission of a fourth control message that indicates the second subset of TD precoder indices of the set of multiple TD precoder indices.

In some examples, the uplink grant manager 1430 is capable of, configured to, or operable to support a means for transmitting, to the UE and prior to the first control message, a second uplink grant via a third control message that schedules a second uplink shared channel communication, where the second uplink grant indicates a second respective TD precoder coefficient for each of a second subset of TD precoder indices of the set of multiple TD precoder indices. In some examples, the uplink reception manager 1435 is capable of, configured to, or operable to support a means for receiving, from the UE, the second uplink shared channel communication in accordance with a default FD precoder based on an absence of transmission of a fourth control message that indicates the second subset of TD precoder indices of the set of multiple TD precoder indices.

In some examples, the TD precoder parameter manager 1455 is capable of, configured to, or operable to support a means for transmitting, to the UE, a third control message that indicates a quantity of TD precoder indices in the TD precoder indices, where the third control message further indicates a quantity of bits to use for indication of each respective TD precoder coefficient.

In some examples, the uplink grant indicates the respective TD precoder coefficient for each of the subset of TD precoder indices via indication of a respective quantized phase and amplitude for each of the subset of TD precoder indices.

In some examples, the uplink grant indicates the respective TD precoder coefficient for each of the subset of TD precoder indices via indication of a respective codeword from a codebook for each of the subset of TD precoder indices.

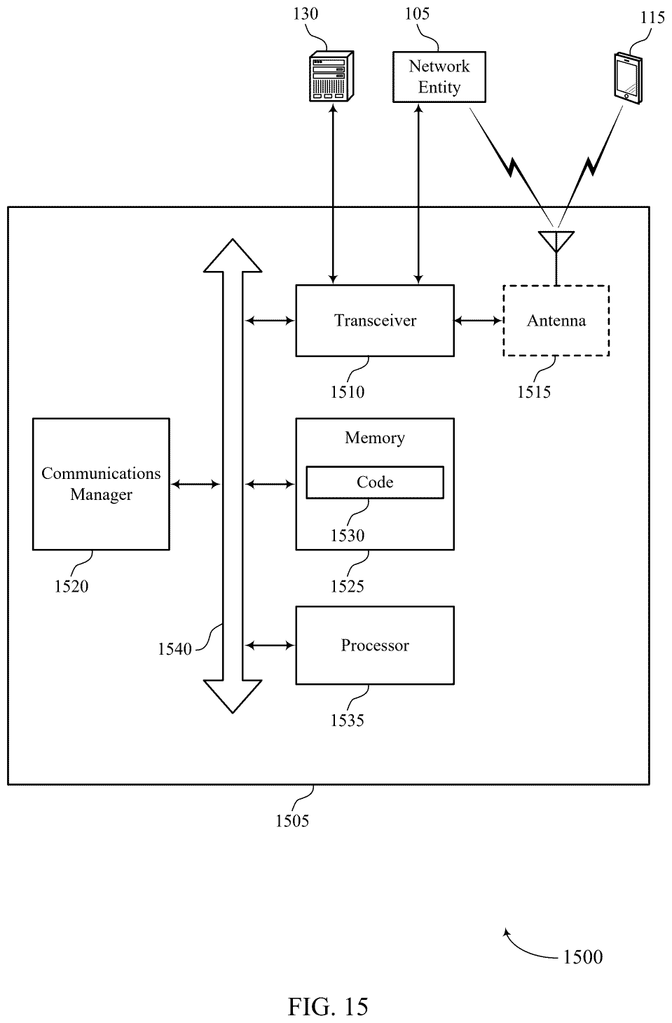

FIG. 15 shows a diagram of a system 1500 including a device 1505 that supports two-stage time-domain uplink precoder indication in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting two-stage time-domain uplink precoder indication). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel. The communications manager 1520 is capable of, configured to, or operable to support a means for transmitting, to the UE, an uplink grant that schedules an uplink shared channel communication, where the uplink grant indicates a respective TD precoder coefficient for each of the subset of TD precoder indices. The communications manager 1520 is capable of, configured to, or operable to support a means for receiving, from the UE, the uplink shared channel communication precoded in accordance with an FD precoder based on each respective TD precoder coefficient.

By including or configuring the communications manager 1520 in accordance with examples as described herein, the device 1505 may support techniques for more efficient utilization of communication resources, improved coordination between devices, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of two-stage time-domain uplink precoder indication as described herein, or the at least one processor 1535 and the at least one memory 1525 may be otherwise configured to, individually or collectively, perform or support such operations.

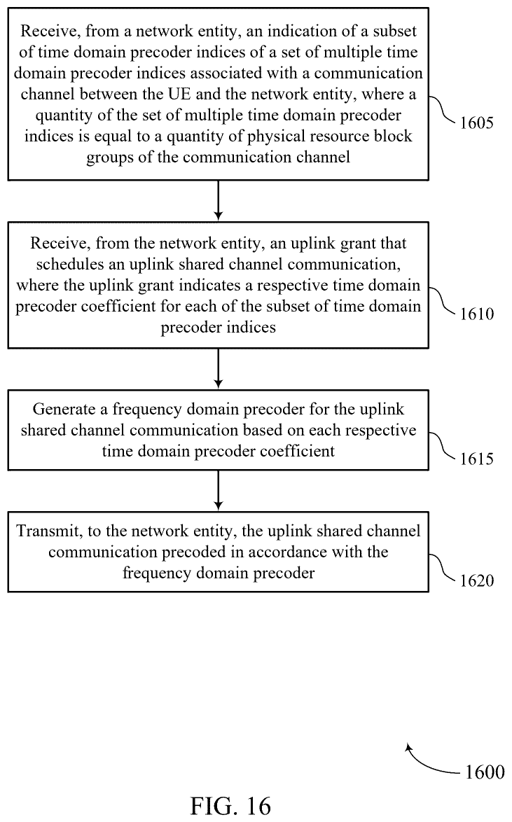

FIG. 16 shows a flowchart illustrating a method 1600 that supports two-stage time-domain uplink precoder indication in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, an indication of a subset of TD precoder indices of a set of multiple TD precoder indices associated with a communication channel between the UE and the network entity, where a quantity of the set of multiple TD precoder indices is equal to a quantity of PRGs of the communication channel. The operations of 1605 may be performed in accordance with examples as disclosed herein. In some examples, aspects of the operations of 1605 may be performed by a TD precoder indices indication manager 1025 as described with reference to FIG. 10.

At 1610, the method may include receiving, from the network entity, an uplink grant that schedules an uplink shared channel communication, where the uplink grant indicates a respective TD precoder coefficient for each of the subset of TD precoder indices. The operations of 1610 may be performed in accordance with examples as disclosed herein. In some examples, aspects of the operations of 1610 may be performed by an uplink grant manager 1030 as described with reference to FIG. 10.

At 1615, the method may include generating an FD precoder for the uplink shared channel communication based on each respective TD precoder coefficient. The operations of 1615 may be performed in accordance with examples as disclosed herein. In some examples, aspects of the operations of 1615 may be performed by an FD precoder manager 1035 as described with reference to FIG. 10.

At 1620, the method may include transmitting, to the network entity, the uplink shared channel communication precoded in accordance with the FD precoder. The operations of 1620 may be performed in accordance with examples as disclosed herein. In some examples, aspects of the operations of 1620 may be performed by an uplink transmission manager 1040 as described with reference to FIG. 10.

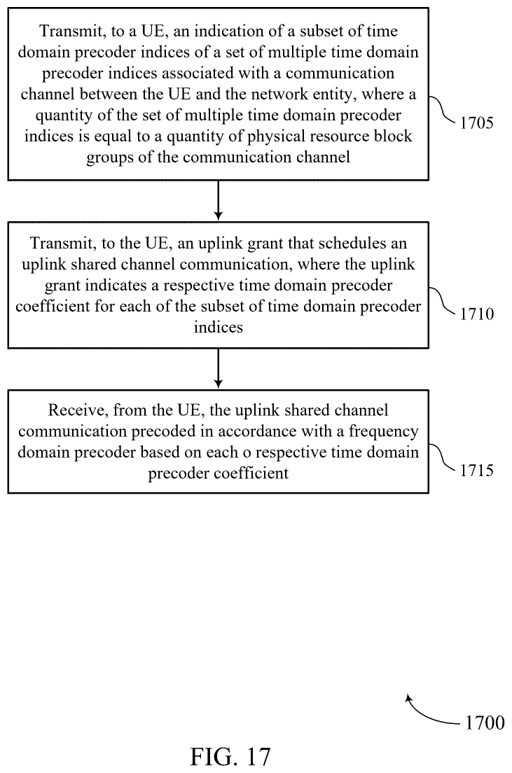

FIG. 17 shows a flowchart illustrating a method 1700 that supports two-stage time-domain uplink precoder indication in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, an indication of a subset of TD precoder indices of a set of multiple TD precoder indices associated with a communication channel between the UE and the network entity, where a quantity of the set of multiple TD precoder indices is equal to a quantity of PRGs of the communication channel. The operations of 1705 may be performed in accordance with examples as disclosed herein. In some examples, aspects of the operations of 1705 may be performed by a TD precoder indices indication manager 1425 as described with reference to FIG. 14.

At 1710, the method may include transmitting, to the UE, an uplink grant that schedules an uplink shared channel communication, where the uplink grant indicates a respective TD precoder coefficient for each of the subset of TD precoder indices. The operations of 1710 may be performed in accordance with examples as disclosed herein. In some examples, aspects of the operations of 1710 may be performed by an uplink grant manager 1430 as described with reference to FIG. 14.

At 1715, the method may include receiving, from the UE, the uplink shared channel communication precoded in accordance with a frequency domain precoder based on each respective TD precoder coefficient. The operations of 1715 may be performed in accordance with examples as disclosed herein. In some examples, aspects of the operations of 1715 may be performed by an uplink reception manager 1435 as described with reference to FIG. 14.

The following provides an overview of aspects of the present disclosure:

Aspect 1: A method for wireless communications at a UE, comprising: receiving, from a network entity, an indication of a subset of TD precoder indices of a plurality of TD precoder indices associated with a communication channel between the UE and the network entity, wherein a quantity of the plurality of TD precoder indices is equal to a quantity of PRGs of the communication channel; receiving, from the network entity, an uplink grant that schedules an uplink shared channel communication, wherein the uplink grant indicates a respective TD precoder coefficient for each of the subset of TD precoder indices; generating a FD precoder for the uplink shared channel communication based at least in part on each respective TD precoder coefficient; and transmitting, to the network entity, the uplink shared channel communication precoded in accordance with the FD precoder.

Aspect 2: The method of aspect 1, wherein generating the FD precoder comprises: generating a TD precoder based on each respective TD precoder coefficient and based on a zero-value for a remainder of the plurality of TD precoder indices that are not included in the subset of TD precoder indices; and applying a fast Fourier transform to the TD precoder to generate the FD precoder.

Aspect 3: The method of any of aspects 1 through 2, wherein the indication of the subset of TD precoder indices is received via the uplink grant.

Aspect 4: The method of any of aspects 1 through 2, wherein the indication of the subset of TD precoder indices is received via a first control message, and wherein the uplink grant is received via a second control message.

Aspect 5: The method of aspect 4, further comprising: receiving, from the network entity, a second uplink grant via a third control message that schedules a second uplink shared channel communication, wherein the second uplink grant indicates a second respective TD precoder coefficient for each of the subset of TD precoder indices; generating a second FD precoder for the second uplink shared channel communication based at least in part on each second respective TD precoder coefficient; and transmitting, to the network entity, the second uplink shared channel communication precoded in accordance with the second FD precoder.

Aspect 6: The method of aspect 5, wherein generating the second FD precoder is based at least in part on the subset of TD precoder indices indicated in the third control message matching the subset of TD precoder indices in the first control message.

Aspect 7: The method of any of aspects 4 through 6, further comprising: receiving, via the first control message, information that indicates a quantity of RBs associated with the plurality of TD precoder indices and a quantity of RBs per PRG.

Aspect 8: The method of any of aspects 4 through 7, further comprising: receiving, from the network entity and prior to the first control message, a second uplink grant via a third control message that schedules a second uplink shared channel communication, wherein the second uplink grant indicates a second respective TD precoder coefficient for each of a second subset of TD precoder indices of the plurality of TD precoder indices; generating a second FD precoder for the second uplink shared channel communication based at least in part on only one second respective TD precoder coefficient based at least in part on an absence of reception of a fourth control message that indicates the second subset of TD precoder indices of the plurality of TD precoder indices; and transmitting, to the network entity, the second uplink shared channel communication precoded in accordance with the second FD precoder.

Aspect 9: The method of any of aspects 4 through 7, further comprising: receiving, from the network entity and prior to the first control message, a second uplink grant via a third control message that schedules a second uplink shared channel communication, wherein the second uplink grant indicates a second respective TD precoder coefficient for each of a second subset of TD precoder indices of the plurality of TD precoder indices; and refraining from transmitting the second uplink shared channel communication based at least in part on an absence of reception of a fourth control message that indicates the second subset of TD precoder indices of the plurality of TD precoder indices.

Aspect 10: The method of any of aspects 4 through 7, further comprising: receiving, from the network entity and prior to the first control message, a second uplink grant via a third control message that schedules a second uplink shared channel communication, wherein the second uplink grant indicates a second respective TD precoder coefficient for each of a second subset of TD precoder indices of the plurality of TD precoder indices; and transmitting, to the network entity, the second uplink shared channel communication precoded in accordance with a default FD precoder based at least in part on an absence of reception of a fourth control message that indicates the second subset of TD precoder indices of the plurality of TD precoder indices.

Aspect 11: The method of any of aspects 4 through 10, further comprising: receiving, from the network entity, a third control message that indicates a quantity of TD precoder indices in the TD precoder indices, wherein the third control message further indicates a quantity of bits to use for indication of each respective TD precoder coefficient, wherein reception of the first control message and the second control message is based at least in part on reception of the third control message.

Aspect 12: The method of any of aspects 1 through 11, wherein the uplink grant indicates the respective TD precoder coefficient for each of the subset of TD precoder indices via indication of a respective quantized phase and amplitude for each of the subset of TD precoder indices.

Aspect 13: The method of any of aspects 1 through 11, wherein the uplink grant indicates the respective TD precoder coefficient for each of the subset of TD precoder indices via indication of a respective codeword from a codebook for each of the subset of TD precoder indices.

Aspect 14: The method of any of aspects 1 through 13, further comprising: transmitting a plurality of SRSs via the communication channel, wherein reception of the indication of the subset of TD precoder indices is based at least in part on transmission of the plurality of SRSs.

Aspect 15: A method for wireless communications at a network entity, comprising: transmitting, to a UE, an indication of a subset of TD precoder indices of a plurality of TD precoder indices associated with a communication channel between the UE and the network entity, wherein a quantity of the plurality of TD precoder indices is equal to a quantity of PRGs of the communication channel; transmitting, to the UE, an uplink grant that schedules an uplink shared channel communication, wherein the uplink grant indicates a respective TD precoder coefficient for each of the subset of TD precoder indices; and receiving, from the UE, the uplink shared channel communication precoded in accordance with a FD precoder based at least in part on each respective TD precoder coefficient.

Aspect 16: The method of aspect 15, further comprising: receiving, from the UE, a plurality of SRSs via the communication channel; generating the FD precoder based at least in part on the plurality of SRSs; generating a TD precoder based at least in part on the FD precoder, the TD precoder comprising a respective TD precoder coefficient for each of the plurality of TD precoder indices; and selecting the subset of TD precoder indices from the plurality of TD precoder indices based at least in part on the respective TD precoder coefficient for the subset of TD precoder indices satisfying a threshold.

Aspect 17: The method of aspect 16, wherein generating the TD precoder comprises: applying an inverse fast Fourier transform to the FD precoder to generate the TD precoder.

Aspect 18: The method of any of aspects 15 through 17, wherein the indication of the subset of TD precoder indices is transmitted via the uplink grant.

Aspect 19: The method of any of aspects 15 through 17, wherein the indication of the subset of TD precoder indices is received via a first control message, and the uplink grant is received via a second control message.

Aspect 20: The method of aspect 19, further comprising: transmitting, to the UE, a second uplink grant via a third control message that schedules a second uplink shared channel communication, wherein the second uplink grant indicates a second respective TD precoder coefficient for each of the subset of TD precoder indices; and receiving, from the UE, the second uplink shared channel communication in accordance with a second FD precoder based at least in part on each second respective TD precoder coefficient.

Aspect 21: The method of aspect 20, wherein receiving the second uplink shared channel communication in accordance with the second FD precoder is based at least in part on the subset of TD precoder indices indicated in the third control message matching the subset of TD precoder indices in the first control message.

Aspect 22: The method of any of aspects 19 through 21, further comprising: transmitting, via the first control message, information that indicates a quantity of RBs associated with the plurality of TD precoder indices and a quantity of RBs per PRG.

Aspect 23: The method of any of aspects 19 through 22, further comprising: transmitting, to the UE and prior to the first control message, a second uplink grant via a third control message that schedules a second uplink shared channel communication, wherein the second uplink grant indicates a second respective TD precoder coefficient for each of a second subset of TD precoder indices of the plurality of TD precoder indices; and receiving, from the UE, the second uplink shared channel communication in accordance with a second FD precoder based at least in part on only one second respective TD precoder coefficient based at least in part on an absence of transmission of a fourth control message that indicates the second subset of TD precoder indices of the plurality of TD precoder indices.

Aspect 24: The method of any of aspects 19 through 22, further comprising: transmitting, to the UE and prior to the first control message, a second uplink grant via a third control message that schedules a second uplink shared channel communication, wherein the second uplink grant indicates a second respective TD precoder coefficient for each of a second subset of TD precoder indices of the plurality of TD precoder indices; and receiving, from the UE, the second uplink shared channel communication in accordance with a default FD precoder based at least in part on an absence of transmission of a fourth control message that indicates the second subset of TD precoder indices of the plurality of TD precoder indices.

Aspect 25: The method of any of aspects 15 through 24, further comprising: transmitting, to the UE, a third control message that indicates a quantity of TD precoder indices in the TD precoder indices, wherein the third control message further indicates a quantity of bits to use for indication of each respective TD precoder coefficient.

Aspect 26: The method of any of aspects 15 through 25, wherein the uplink grant indicates the respective TD precoder coefficient for each of the subset of TD precoder indices via indication of a respective quantized phase and amplitude for each of the subset of TD precoder indices.

Aspect 27: The method of any of aspects 15 through 25, wherein the uplink grant indicates the respective TD precoder coefficient for each of the subset of TD precoder indices via indication of a respective codeword from a codebook for each of the subset of TD precoder indices.

Aspect 28: A UE for wireless communications, comprising one or more memories storing processor-executable code, and one or more processors coupled with the one or more memories and individually or collectively operable to execute the code to cause the UE to perform a method of any of aspects 1 through 14.

Aspect 29: A UE for wireless communications, comprising at least one means for performing a method of any of aspects 1 through 14.

Aspect 30: A non-transitory computer-readable medium storing code for wireless communications, the code comprising instructions executable by one or more processors to perform a method of any of aspects 1 through 14.

Aspect 31: A network entity for wireless communications, comprising one or more memories storing processor-executable code, and one or more processors coupled with the one or more memories and individually or collectively operable to execute the code to cause the network entity to perform a method of any of aspects 15 through 27.

Aspect 32: A network entity for wireless communications, comprising at least one means for performing a method of any of aspects 15 through 27.

Aspect 33: A non-transitory computer-readable medium storing code for wireless communications, the code comprising instructions executable by one or more processors to perform a method of any of aspects 15 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, an indication of a subset of time domain precoder indices of a plurality of time domain precoder indices associated with a communication channel between the UE and the network entity, wherein a quantity of the plurality of time domain precoder indices is equal to a quantity of physical resource block groups of the communication channel;
receive, from the network entity, an uplink grant that schedules an uplink shared channel communication, wherein the uplink grant indicates a respective time domain precoder coefficient for each of the subset of time domain precoder indices;
generate a frequency domain precoder for the uplink shared channel communication based at least in part on each respective time domain precoder coefficient; and
transmit, to the network entity, the uplink shared channel communication precoded in accordance with the frequency domain precoder.

2. The UE of claim 1, wherein, to generate the frequency domain precoder, the one or more processors are individually or collectively operable to execute the code to cause the UE to:
generate a time domain precoder based on each respective time domain precoder coefficient and based on a zero-value for a remainder of the plurality of time domain precoder indices that are not included in the subset of time domain precoder indices; and
apply a fast Fourier transform to the time domain precoder to generate the frequency domain precoder.

3. The UE of claim 1, wherein the indication of the subset of time domain precoder indices is received via the uplink grant.

4. The UE of claim 1, wherein:
the indication of the subset of time domain precoder indices is received via a first control message, and
the uplink grant is received via a second control message.

5. The UE of claim 4, wherein the one or more processors are individually or collectively further operable to execute the code to cause the UE to:
receive, from the network entity, a second uplink grant via a third control message that schedules a second uplink shared channel communication, wherein the second uplink grant indicates a second respective time domain precoder coefficient for each of the subset of time domain precoder indices;
generate a second frequency domain precoder for the second uplink shared channel communication based at least in part on each second respective time domain precoder coefficient; and
transmit, to the network entity, the second uplink shared channel communication precoded in accordance with the second frequency domain precoder.

6. The UE of claim 5, wherein generating the second frequency domain precoder is based at least in part on the subset of time domain precoder indices indicated in the third control message matching the subset of time domain precoder indices in the first control message.

7. The UE of claim 4, wherein the one or more processors are individually or collectively further operable to execute the code to cause the UE to:
receive, via the first control message, information that indicates a quantity of resource blocks associated with the plurality of time domain precoder indices and a quantity of resource blocks per physical resource block group.

8. The UE of claim 4, wherein the one or more processors are individually or collectively further operable to execute the code to cause the UE to:
receive, from the network entity and prior to the first control message, a second uplink grant via a third control message that schedules a second uplink shared channel communication, wherein the second uplink grant indicates a second respective time domain precoder coefficient for each of a second subset of time domain precoder indices of the plurality of time domain precoder indices;
generate a second frequency domain precoder for the second uplink shared channel communication based at least in part on only one second respective time domain precoder coefficient based at least in part on an absence of reception of a fourth control message that indicates the second subset of time domain precoder indices of the plurality of time domain precoder indices; and
transmit, to the network entity, the second uplink shared channel communication precoded in accordance with the second frequency domain precoder.

9. The UE of claim 4, wherein the one or more processors are individually or collectively further operable to execute the code to cause the UE to:
receive, from the network entity and prior to the first control message, a second uplink grant via a third control message that schedules a second uplink shared channel communication, wherein the second uplink grant indicates a second respective time domain precoder coefficient for each of a second subset of time domain precoder indices of the plurality of time domain precoder indices; and
refrain from transmitting the second uplink shared channel communication based at least in part on an absence of reception of a fourth control message that indicates the second subset of time domain precoder indices of the plurality of time domain precoder indices.

10. The UE of claim 4, wherein the one or more processors are individually or collectively further operable to execute the code to cause the UE to:
receive, from the network entity and prior to the first control message, a second uplink grant via a third control message that schedules a second uplink shared channel communication, wherein the second uplink grant indicates a second respective time domain precoder coefficient for each of a second subset of time domain precoder indices of the plurality of time domain precoder indices; and
transmit, to the network entity, the second uplink shared channel communication precoded in accordance with a default frequency domain precoder based at least in part on an absence of reception of a fourth control message that indicates the second subset of time domain precoder indices of the plurality of time domain precoder indices.

11. The UE of claim 4, wherein the one or more processors are individually or collectively further operable to execute the code to cause the UE to:
receive, from the network entity, a third control message that indicates a quantity of time domain precoder indices in the time domain precoder indices, wherein the third control message further indicates a quantity of bits to use for indication of each respective time domain precoder coefficient, wherein reception of the first control message and the second control message is based at least in part on reception of the third control message.

12. The UE of claim 1, wherein the uplink grant indicates the respective time domain precoder coefficient for each of the subset of time domain precoder indices via indication of a respective quantized phase and amplitude for each of the subset of time domain precoder indices.

13. The UE of claim 1, wherein the uplink grant indicates the respective time domain precoder coefficient for each of the subset of time domain precoder indices via indication of a respective codeword from a codebook for each of the subset of time domain precoder indices.

14. The UE of claim 1, wherein the one or more processors are individually or collectively further operable to execute the code to cause the UE to:
transmit a plurality of sounding reference signals via the communication channel, wherein reception of the indication of the subset of time domain precoder indices is based at least in part on transmission of the plurality of sounding reference signals.

15. A network entity, comprising:
one or more memories storing processor-executable code; and
one or more processors coupled with the one or more memories and individually or collectively operable to execute the code to cause the network entity to:
transmit, to a user equipment (UE), an indication of a subset of time domain precoder indices of a plurality of time domain precoder indices associated with a communication channel between the UE and the network entity, wherein a quantity of the plurality of time domain precoder indices is equal to a quantity of physical resource block groups of the communication channel;
transmit, to the UE, an uplink grant that schedules an uplink shared channel communication, wherein the uplink grant indicates a respective time domain precoder coefficient for each of the subset of time domain precoder indices; and
receive, from the UE, the uplink shared channel communication precoded in accordance with a frequency domain precoder based at least in part on each respective time domain precoder coefficient.

16. The network entity of claim 15, wherein the one or more processors are individually or collectively further operable to execute the code to cause the network entity to:
receive, from the UE, a plurality of sounding reference signals via the communication channel;
generate the frequency domain precoder based at least in part on the plurality of sounding reference signals;
generate a time domain precoder based at least in part on the frequency domain precoder, the time domain precoder comprising a respective time domain precoder coefficient for each of the plurality of time domain precoder indices; and
select the subset of time domain precoder indices from the plurality of time domain precoder indices based at least in part on the respective time domain precoder coefficient for the subset of time domain precoder indices satisfying a threshold.

17. The network entity of claim 16, wherein, to generate the time domain precoder, the one or more processors are individually or collectively operable to execute the code to cause the network entity to:
apply an inverse fast Fourier transform to the frequency domain precoder to generate the time domain precoder.

18. The network entity of claim 15, wherein the indication of the subset of time domain precoder indices is received via the uplink grant.

19. The network entity of claim 15, wherein:
the indication of the subset of time domain precoder indices is received via a first control message, and
the uplink grant is received via a second control message.

20. The network entity of claim 19, wherein the one or more processors are individually or collectively further operable to execute the code to cause the network entity to:
transmit, to the UE, a second uplink grant via a third control message that schedules a second uplink shared channel communication, wherein the second uplink grant indicates a second respective time domain precoder coefficient for each of the subset of time domain precoder indices; and
receive, from the UE, the second uplink shared channel communication in accordance with a second frequency domain precoder based at least in part on each second respective time domain precoder coefficient.

21. The network entity of claim 20, wherein receiving the second uplink shared channel communication in accordance with the second frequency domain precoder is based at least in part on the subset of time domain precoder indices indicated in the third control message matching the subset of time domain precoder indices in the first control message.

22. The network entity of claim 19, wherein the one or more processors are individually or collectively further operable to execute the code to cause the network entity to:
transmit, via the first control message, information that indicates a quantity of resource blocks associated with the plurality of time domain precoder indices and a quantity of resource blocks per physical resource block group.

23. The network entity of claim 19, wherein the one or more processors are individually or collectively further operable to execute the code to cause the network entity to:
transmit, to the UE and prior to the first control message, a second uplink grant via a third control message that schedules a second uplink shared channel communication, wherein the second uplink grant indicates a second respective time domain precoder coefficient for each of a second subset of time domain precoder indices of the plurality of time domain precoder indices; and
receive, from the UE, the second uplink shared channel communication in accordance with a second frequency domain precoder based at least in part on only one second respective time domain precoder coefficient based at least in part on an absence of transmission of a fourth control message that indicates the second subset of time domain precoder indices of the plurality of time domain precoder indices.

24. The network entity of claim 19, wherein the one or more processors are individually or collectively further operable to execute the code to cause the network entity to:
transmit, to the UE and prior to the first control message, a second uplink grant via a third control message that schedules a second uplink shared channel communication, wherein the second uplink grant indicates a second respective time domain precoder coefficient for each of a second subset of time domain precoder indices of the plurality of time domain precoder indices; and
receive, from the UE, the second uplink shared channel communication in accordance with a default frequency domain precoder based at least in part on an absence of transmission of a fourth control message that indicates the second subset of time domain precoder indices of the plurality of time domain precoder indices.

25. The network entity of claim 19, wherein the one or more processors are individually or collectively further operable to execute the code to cause the network entity to:
transmit, to the UE, a third control message that indicates a quantity of time domain precoder indices in the time domain precoder indices, wherein the third control message further indicates a quantity of bits to use for indication of each respective time domain precoder coefficient.

26. The network entity of claim 15, wherein the uplink grant indicates the respective time domain precoder coefficient for each of the subset of time domain precoder indices via indication of a respective quantized phase and amplitude for each of the subset of time domain precoder indices.

27. The network entity of claim 15, wherein the uplink grant indicates the respective time domain precoder coefficient for each of the subset of time domain precoder indices via indication of a respective codeword from a codebook for each of the subset of time domain precoder indices.

28. A method for wireless communications at a user equipment (UE), comprising:
receiving, from a network entity, an indication of a subset of time domain precoder indices of a plurality of time domain precoder indices associated with a communication channel between the UE and the network entity, wherein a quantity of the plurality of time domain precoder indices is equal to a quantity of physical resource block groups of the communication channel;
receiving, from the network entity, an uplink grant that schedules an uplink shared channel communication, wherein the uplink grant indicates a respective time domain precoder coefficient for each of the subset of time domain precoder indices;
generating a frequency domain precoder for the uplink shared channel communication based at least in part on each respective time domain precoder coefficient; and
transmitting, to the network entity, the uplink shared channel communication precoded in accordance with the frequency domain precoder.

29. The method of claim 28, wherein generating the frequency domain precoder comprises:
generating a time domain precoder based on each respective time domain precoder coefficient and based on a zero-value for a remainder of the plurality of time domain precoder indices that are not included in the subset of time domain precoder indices; and
applying a fast Fourier transform to the time domain precoder to generate the frequency domain precoder.

30. A method for wireless communications at a network entity, comprising:
transmitting, to a user equipment (UE), an indication of a subset of time domain precoder indices of a plurality of time domain precoder indices associated with a communication channel between the UE and the network entity, wherein a quantity of the plurality of time domain precoder indices is equal to a quantity of physical resource block groups of the communication channel;
transmitting, to the UE, an uplink grant that schedules an uplink shared channel communication, wherein the uplink grant indicates a respective time domain precoder coefficient for each of the subset of time domain precoder indices; and
receiving, from the UE, the uplink shared channel communication precoded in accordance with a frequency domain precoder based at least in part on each respective time domain precoder coefficient.
